(19) United States
(12) Patent Application Publication
(10) Pub. No.: US 2026/0285728 A1
(43) Pub. Date: Sep. 24, 2026

(54) HYBRID ELECTRODIALYSIS AND ELECTROLYSIS SYSTEMS AND PROCESSES

(71) Applicant: PANI CLEAN, INC., Coralville, IA (US)

(72) Inventor: Joun Lee, Coralville, IA (US)

(21) Appl. No.: 19/692,857

(22) Filed: May 29, 2026

Related U.S. Application Data
(63) Continuation-in-part of application No. 17/345,982, filed on Jun. 11, 2021, now Pat. No. 12,662,401.
(60) Provisional application No. 63/038,625, filed on Jun. 12, 2020.

(51) Int. Cl. C02F 9/00; C02F 1/20; C02F 1/42; C02F 1/461; C02F 1/469; C02F 101/16

(52) U.S. Cl. CPC C02F 9/00; C02F 1/20; C02F 1/42; C02F 2001/422; C02F 2001/425; C02F 1/46109; C02F 2001/46142; C02F 2001/46161; C02F 1/4693; C02F 2101/16; C02F 2201/004; C02F 2201/005; C02F 2201/46145; C02F 2201/4617; C02F 2209/40

(57) ABSTRACT

Disclosed are systems and processes for the removal and conversion of pollutants in water. A system includes a set of electrodes with at least one electrode having an integrated catalyst material. The system is operatable in a first, electrodialysis mode in which one or more pollutants are separated from a feedwater stream, and a second electrolysis mode in which the separated pollutant(s) are catalytically converted into benign products by way of the catalyst material of the electrode. Electrodialysis and electrolysis are therefore carried out using the same unit.

### CROSS-REFERENCE TO RELATED APPLICATIONS

This application is a continuation in part of U.S. patent application Ser. No. 17/345,982, filed on Jun. 11, 2021, which claims priority to and the benefit of U.S. Provisional Patent Application No. 63/038,625, filed on Jun. 12, 2020, the contents of which are fully incorporated herein by reference.

### STATEMENT REGARDING FEDERALLY SPONSORED RESEARCH

This invention was made with government support under grant no. 2019-33610-29769 awarded by the United States Department of Agriculture, National Institute of Food and Agriculture. The government has certain rights in the invention.

### SUMMARY

In accordance with one aspect, there is provided a system for removing and electro-reducing nitrogen-based anions from feedwater comprising nitrogen-based solutes. The system may comprise an integrated electrodialysis and electrolysis device comprising a first electrode. The system may comprise a second electrode positioned opposite the first electrode. The system may comprise a first ion exchange membrane adjacent to the first electrode, and a second ion exchange membrane adjacent to the second electrode and positioned between the first and the second electrodes to define a central compartment between the first and second ion exchange membranes, a first electrode compartment defined between said first ion exchange membrane and the first electrode, and a second electrode compartment defined between said second ion exchange membrane and the second electrode. The system may comprise feedwater inlets and effluent outlets in fluid communication with said central compartment and said first electrode compartment and said second electrode compartment. The system may comprise a source of DC electrical power connected to said first electrode and said second electrode.

The first electrode may be adjacent to or in direct contact with said first electrode compartment and may comprise an electrically conductive 3-dimensional macroporous open-cell scaffold comprising a coating of a selective electro-reductive catalyst for nitrogen-based ion reduction, the scaffold having an electrochemically active surface area of greater than 10 times its compartment-exposed geometric area.

In some embodiments, the scaffold surface may be comprised of nickel or titanium.

The system may further comprise fluid control valves in fluid communication with each of the feedwater inlets and effluent outlets and arranged to control inlet and effluent water flows and combinations thereof to and from each of the respective compartments.

The system may be comprised of at least two systems operating in series.

The system may further comprise a plurality of ordered and repeating cation exchange membranes and anion exchange membranes positioned between said first and second ion exchange membranes and defining a plurality of central compartments to form alternating diluting and concentrating compartments.

In some embodiments, at least one of the effluent outlets of the central concentrating compartments or the effluent outlet of the second electrode compartment may be in fluid communication with the feedwater inlet of the first electrode compartment.

In accordance with another aspect, there is provided a method for removing and electro-reducing nitrate-based anion from feedwater comprising nitrate or nitrite solutes. The method may comprise providing an integrated electrodialysis and electrolysis hybrid system comprising a first electrode comprised of an electrically conductive chemically inert scaffold material having a coating of selective electro-reductive catalyst for nitrate reduction, a second electrode positioned opposite the first electrode, and a first ion exchange membrane adjacent to the first electrode, and a second ion exchange membrane adjacent to the second electrode and positioned between the first and the second electrodes to define a central compartment between the anion exchange membrane and the cation exchange membrane, a first electrode compartment defined between said first ion exchange membrane and the first electrode, and a second electrode compartment defined between said second ion exchange membrane and the second electrode. The method may comprise passing the feedwater water into the central compartment and the first and the second electrode compartments. The method may comprise operating the hybrid system for a first time period in an electrodialysis mode by imposing an anodic polarity across the first electrode and a cathodic polarity across the second electrode to produce a concentration of nitrate or nitrite ion in the central compartment that is lower than the concentration of nitrate or nitrite ion in the feedwater, and producing a water in the first electrode compartment that includes nitrate or nitrite anions. The method may comprise operating the hybrid system, for a second time period, in an electrolysis mode by reversing the polarity across the first and the second electrodes, such that the first electrode becomes cathodic with respect to the second electrode, and whereby nitrate or nitrite in the first electrode compartment is electro-reduced to form one or a combination of reaction products comprising nitrite, ammonia, ammonium, or nitrogen gas.

The hybrid system may comprise two or more central compartments and may be operated such that the first electrode compartment is fluidly connected with at least one the effluent outlets of the central compartments that are in concentration mode or the outlet of the second electrode compartment during the time period when the hybrid system is operated in the electrolysis mode and wherein electrodialysis and electroreduction occurs simultaneously and wherein the electrical polarity of the first and second electrodes is not reversed.

The hybrid system may be comprised of at least two systems operated in series and the feedwater inlet to the first electrode compartment may be fluidly connected to the effluent outlet of the second electrode compartment when the hybrid system is operated in either or both the electrolysis mode or electrodialysis mode.

In accordance with another aspect, there is provided a system for removing and electro-reducing nitrogen-based anions from feedwater comprising nitrogen-based solutes. The system may comprise an integrated electrodialysis and electrolysis device comprising a first electrode. The system may comprise a second electrode positioned opposite the first electrode. The system may comprise a first ion exchange membrane adjacent to the first electrode, and a second ion exchange membrane adjacent to the second electrode and positioned between the first and the second electrodes, a plurality of ordered and repeating cation exchange membranes and anion exchange membranes positioned between said ion exchange membranes, and defining a plurality of central compartments forming alternating diluting and concentrating compartments between the ion exchange membranes, a first electrode compartment defined between said first ion exchange membrane and the first electrode, and a second electrode compartment defined between said second ion exchange membrane and the second electrode. The system may comprise feedwater inlets and effluent outlets in fluid communication with said central compartments and said first electrode compartment and said second electrode compartment. The system may comprise a source of DC electrical power connected to said first electrode and said second electrode.

The system may further comprise fluid control valves in fluid communication with each of the feedwater and electrode compartment inlets and effluent outlets and arranged to control changes in the feedwater and effluent water flows and combinations thereof to and from each of the respective compartments.

At least one of the first electrode and second electrode may comprise an electrically conductive 3-dimensional macroporous open-cell scaffold comprising a chemically inert scaffold material comprising a coating of a selective electro-reductive catalyst for nitrate-based anion reduction, the scaffold having an electrochemically active surface area of greater than 10 times its compartment-exposed geometric area.

In some embodiments, said scaffold surfaces may be coated with a copper catalyst.

In some embodiments, said scaffold surfaces may be comprised of nickel or titanium.

At least one of the effluent outlets of the concentrating compartments and the effluent outlet of the second electrode compartment are in fluid communication with the feedwater inlet of the first electrode compartment and/or at least one of the effluent outlets of the concentrating compartments and the effluent outlet of the first electrode compartment may be in fluid communication with the feedwater inlet of the second electrode compartment.

In some embodiments, the system may further comprise at least one of a first holding tank in fluid communication with the first electrode compartment and configured to receive and recirculate a concentrate stream to the first electrode compartment, a second holding tank in fluid communication with the second electrode compartment and configured to receive the effluent of the second electrode compartment prior to introduction of the effluent into the first electrode compartment, and a third holding tank configured to receive and store the effluent stream from the one or more central compartments prior to feeding the effluent stream to the second electrode compartment.

In some embodiments, the system may further comprise a degasifier positioned at least one of between the second holding tank and the first electrode compartment and upstream of the second electrode compartment, wherein the degasifier is configured to remove oxygen gas from at least one of the effluent of the second electrode compartment prior to introduction of the effluent into the first electrode compartment and the stream from the first electrode compartment and/or effluent stream prior to introduction into the second electrode compartment.

In some embodiments, the ion exchange membrane adjacent to the first electrode and the ion exchange membrane adjacent to the second electrode may be independently selected from a cation exchange membrane or an anion exchange membrane.

A method of operating the system may comprise operating the first electrode and the second electrode under a first polarity condition in which the first electrode functions as a cathode and electroreduces nitrogen-based anions to produce a selected distribution of reduced nitrogen based products, wherein the selected distribution of reduced nitrogen-based products is controlled by varying one or more of catalyst composition, pH of a solution in contact with the first electrode compartment during electroreduction, operating voltage gradient at a catalyst surface, and residence time of a nitrogen species within the first electrode compartment. The method of operating the system may comprise controlling one or more valves to direct feedwater through alternating opposing cells defined by the plurality of ordered and repeating cation exchange membranes and anion exchange membranes such that water purification and nitrate concentration occur continuously regardless of whether polarity of the electrodes is reversed or not reversed.

The disclosure contemplates all combinations of any one or more of the foregoing aspects and/or embodiments, as well as combinations with any one or more of the embodiments set forth in the detailed description and any examples.

### BRIEF DESCRIPTION OF THE DRAWINGS

The accompanying drawings are not intended to be drawn to scale. In the drawings, each identical or nearly identical component that is illustrated in various FIGURES is represented by a like numeral. For purposes of clarity, not every component may be labeled in every drawing. In the drawings:

FIG. 1A is a schematic drawing of a hybrid electrodialysis and electrolysis system in an electrodialysis mode under pH neutral or pH acidic conditions, according to one embodiment;

FIG. 1B is a schematic drawing of the system of FIG. 1A in an electrolysis mode under acidic conditions, according to one embodiment;

FIG. 1C is a schematic drawing of a hybrid electrodialysis and electrolysis system in an electrodialysis mode under alkaline conditions, according to one embodiment;

FIG. 1D is a schematic drawing of a hybrid electrodialysis and electrolysis system in an electrolysis mode under alkaline conditions, according to one embodiment;

FIGS. 2A-2C illustrate results from electrochemical impedance spectroscopy (EIS) testing, showing series resistance results for different carbon materials (FIG. 2A), charge transfer resistances for the tested carbon materials (FIG. 2B), and electrochemically active surface area of the tested carbon materials (FIG. 2C);

FIG. 2D compares the desalination performance over time of a “3D” carbon foam electrode and a conventional platinum (Pt) planar electrode;

FIG. 3A illustrates an SEM image of copper (Cu) nanoparticles deposited on a nickel foam substrate.

FIG. 3B illustrates an SEM image of copper (Cu) nanoparticles deposited on a carbon foam substrate.

FIG. 4 illustrates an SEM images of a copper (Cu) thin film electrodeposited on a carbon substrate;

FIG. 5A compares polarization curves of Pd—Cu electrocatalysts in different electrolytes (NaOH, NO₂, and NO₃);

FIG. 5B compares polarization curves showing NO₃ reduction for different catalyst systems (Cu—Pd, Cu, and Pd);

FIG. 6A illustrates results of a nitrate conversion test, showing operation of Pd—Cu nanoparticles at 3.2 V for over 100 hours; and

FIG. 6B illustrates the proportions of products obtained in the nitrate conversion test for different catalysts utilized;

FIG. 7A illustrates half-cell reduction and oxidation reactions under acidic conditions, according to one embodiment,

FIG. 7B illustrates half-cell reduction and oxidation reactions under alkaline conditions, according to one embodiment;

FIG. 8A is a schematic drawing of a hybrid electrodialysis and electrolysis system comprising multiple central compartments wherein both the first and second electrode compartments are adjacent to cation permeable membranes, according to one embodiment;

FIG. 8B is a schematic drawing of a hybrid electrodialysis and electrolysis system comprising multiple central compartments wherein the first electrode compartment is adjacent to an anion permeable membrane and the second electrode compartment is adjacent to a cation permeable membrane, according to one embodiment;

FIG. 9A is a schematic drawing of a hybrid electrodialysis and electrolysis system in an electrodialysis mode, according to one embodiment;

FIG. 9B is a schematic drawing of a hybrid electrodialysis and electrolysis system in an electrolysis mode, according to one embodiment,

FIG. 10 is a schematic drawing of a system setup used to test nitrate adsorption in capacitive deionization mode;

FIG. 11 illustrates desalination performance of the 3D electrodes of FIG. 10 as a function of time;

FIGS. 12A-C illustrate an electrodialysis and electrolysis unit, reactor housings, and catalyst-coated 3D electrodes suitable for nitrogen-based anion removal and nitrate conversion;

FIG. 13A illustrates nitrate removal and repeated nitrate conversion performance of an integrated electrodialysis and electrolysis system;

FIG. 13B illustrates combined nitrate and nitrite removal and consequential ammonia/ammonium production of an integrated electrodialysis and electrolysis system for different runs;

FIG. 14 illustrates conversion of combined nitrate and nitrite removal and subsequent ammonia/ammonium production as a function of time for an integrated electrodialysis and electrolysis system.

### DETAILED DESCRIPTION

### Overview of Electrodialysis/Electrolysis Systems

Embodiments described herein include systems and processes for the removal of pollutants from water and their conversion to less harmful and/or high value products. Certain embodiments are directed to systems configured to provide bi-functional operation in which (1) a first polarity provides an electrodialysis mode for removing one or more target pollutants from a feedwater stream, and (2) a second, reversed polarity provides an electrolysis mode for converting concentrated pollutant(s) to environmentally benign, less harmful, and/or value-added products. The electrodialysis and electrolysis modes are provided by the same system, thereby minimizing or negating the need for a separate, independent electrolysis system or other conversion system downstream of the electrodialysis system.

In some embodiments, the integrated electrodialysis and electrolysis system is operated in a staged manner in which a nitrate-containing feedwater (in these embodiments and in those following, the feedwater may also comprise other nitrogen based anions and as such, for example nitrite, acts similarly to nitrate) is first processed in an electrodialysis mode to separate the feedwater into a nitrate-depleted diluate stream and a nitrate-enriched concentrate stream. In some embodiments, the feedwater may comprise a mixture of nitrate solutes and other anionic and cationic solutes. During the electrodialysis mode, a first polarity is applied across the electrodes such that nitrate anions migrate through one or more anion exchange membranes from a feedwater or diluting compartment into an anion concentrating compartment. The nitrate-depleted diluate is collected separately from the nitrate-enriched concentrate. In this manner, nitrate is removed from the feedwater without immediately requiring electrochemical reduction of all nitrate present in the system. In embodiments utilizing multiple membrane pairs, nitrate and other anions may be progressively concentrated within intermediate compartments bounded by adjacent anion and cation exchange membranes, resulting in multiple localized regions of elevated pollutant concentration and purified streams between membrane pairs and a single set of first and second electrodes. In such multicell central compartment embodiments both electrodialysis and electrolysis modes can occur simultaneously and continuously, collecting the effluent from the diluting streams as purified water product, and diverting the effluent from the concentrating streams to feed the inlet of the compartment adjacent to the first electrode when operated as a cathode to electro-reduce nitrate and collecting the resultant valuable or inert nitrogen compounds as products.

The electrodialysis mode may be continued until the nitrate concentration in the diluate reaches a selected target level. For example, the electrodialysis mode may be continued until the nitrate concentration in the diluate is reduced below a regulatory, discharge, reuse, process, or product target. In some embodiments, the nitrate concentration in the diluate is reduced by at least 50%, at least 75%, at least 90%, at least 95%, at least 99%, or at least 99.5% relative to the nitrate concentration of the feedwater. In particular embodiments, the diluate may be collected as a treated-water stream, while the nitrate-enriched concentrate is retained for subsequent electrochemical conversion.

After the electrodialysis concentration step, the system may be transitioned from the electrodialysis mode to an electrolysis mode. In some embodiments, this transition includes reversing the polarity of the first and second electrodes. In the electrodialysis mode, the electrode adjacent to the anion concentrating compartment may be operated as an anode or positively charged electrode to attract nitrate anions through the anion exchange membrane. In the electrolysis mode, the polarity is reversed such that the same electrode becomes cathodic. The nitrate-enriched concentrate is then contacted with, passed through, or recirculated along the cathodic chamber containing the nitrate-reduction catalyst. In certain embodiments, fluid communication pathways are provided such that concentrated streams, for example nitrate-rich water captured between adjacent membrane pairs, are recycled or directed through the cathodic electrode compartment during the electrolysis mode, thereby increasing residence time and improving conversion efficiency.

In other embodiments, however, the system may be initially operated in the electrolysis mode when the feedwater or feedstock supplied to the system already contains nitrate, nitrite, ammonia, ammonium, or combinations thereof at a concentration selected for electrochemical conversion. In such embodiments, electrodialytic pre-concentration is optional and the feedwater or feedstock may be introduced directly into, recirculated through, or contacted with the compartment adjacent to the electrode operating as a cathode. The electrode configured for nitrate reduction may be maintained as the cathode during operation, and polarity reversal from an electrodialysis mode is not required before electroreduction begins.

In some embodiments, two or more integrated electrodialysis and electrolysis systems or devices may be fluidly connected in series such that an effluent outlet of a first device is in fluid communication with a feedwater inlet of a second device. The first device and the second device may be operated under the same operating mode or under different operating modes. For example, a first device may be operated to reduce nitrate concentration, increase nitrate concentration in a concentrate stream, or partially electroreduce nitrate, and the effluent from the first device may be supplied to a second device for further nitrate removal, further nitrate concentration, further electroreduction, or adjustment of the ratio of nitrate, nitrite, ammonia, ammonium, nitrogen gas, or combinations thereof. Additional devices may be connected in series to increase treatment capacity, increase conversion, improve product selectivity, or obtain a selected treated-water or nitrogen-containing product compositions.

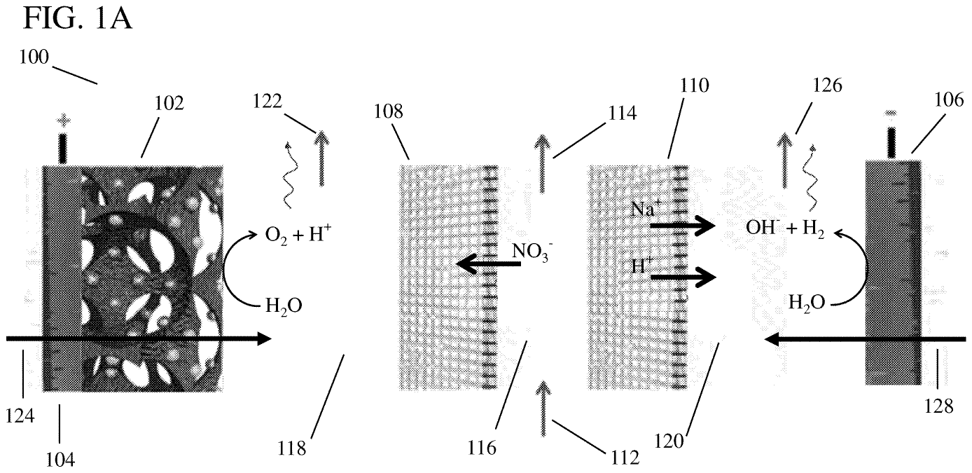

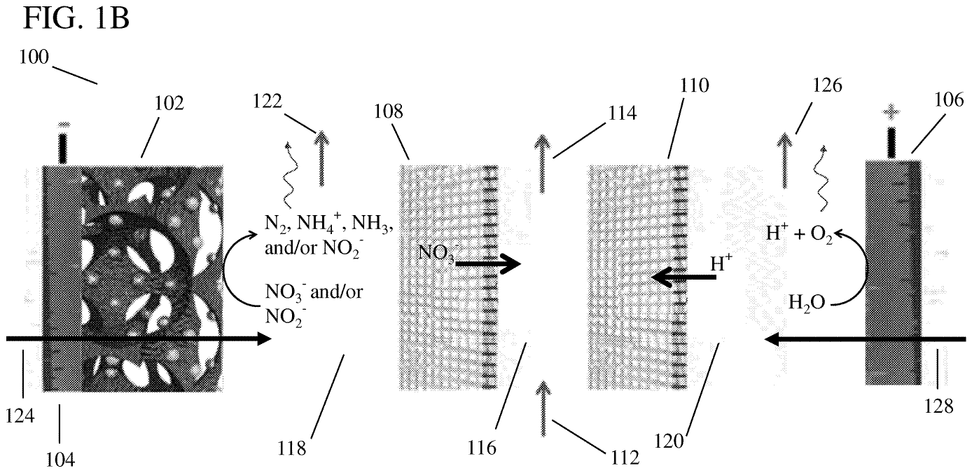

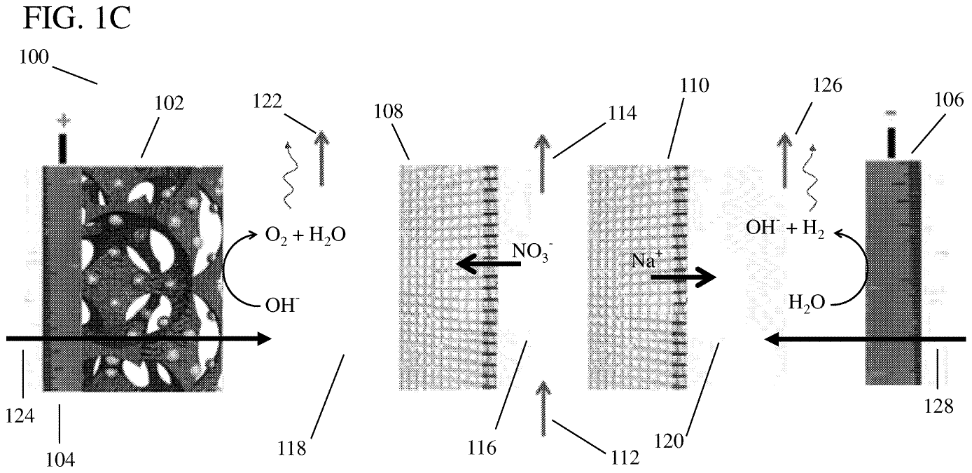

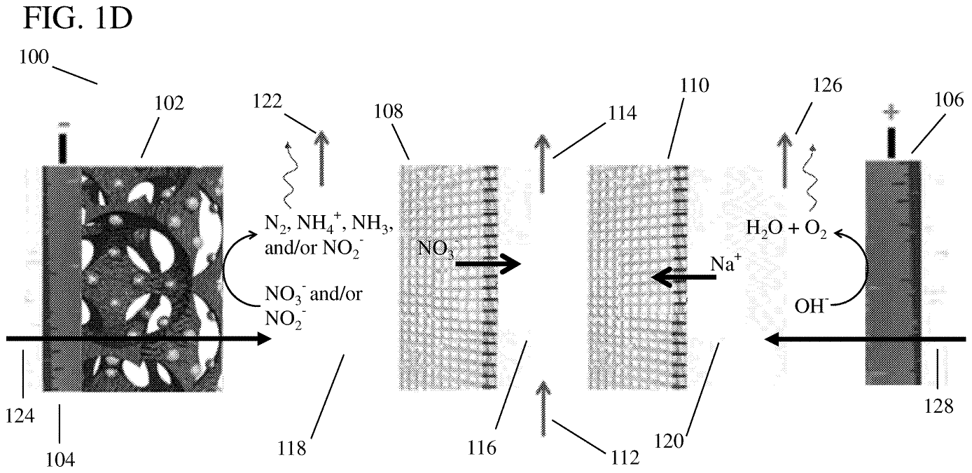

FIGS. 1A and 1B illustrate a hybrid electrodialysis and electrolysis system (100) under acidic conditions, according to one embodiment. The illustrated system (100) includes a first electrode (104) and an opposing second electrode (106). At least one anion exchange membrane (108) and at least one cation exchange membrane (110) are disposed between the electrodes (104 and 106). Ion exchange membranes and other electrodialysis components as known in the art may be utilized, such as membranes components sold under the trade name NEOSEPTA (Astom Corp.) and components sold by PCCell Gmbh.

The ion exchange membranes (108 and 110) are spaced such that a feedwater compartment (116) in formed therebetween. The feedwater compartment (116) is configured to receive an inlet stream (112) with high relative concentration of pollutant(s) and to output an outlet stream (114) with lowered concentration of pollutant(s). The anion exchange membrane (108) and the first electrode (104) define an anion concentration compartment (118) formed therebetween. The cation exchange membrane (110) and the second electrode (106) define a cation concentration compartment (120) formed therebetween. Both the anion concentration compartment (118) and the cation concentration compartment (120) are configured to receive an inlet stream (124 and 128, respectively) through their respective electrodes and to output an outlet stream (122 and 126, respectively).

In electrodialysis mode operation (FIG. 1A), one or more ions pass from the feedwater compartment (116) toward their respective electrodes of opposite charge. In the illustrated example, the first electrode (104) is provided with a positive charge and the second electrode (106) is provided with a negative charge. Referring to nitrate (a negatively charged ion) as an example pollutant targeted for removal, the nitrate passes from the feedwater compartment (116), through the anion exchange membrane (108), and into the anion concentration compartment (118), which is disposed adjacent to the first electrode (104). One or more types of cations (e.g., sodium ions) may pass from the feedwater compartment (116), through the cation exchange membrane (110), and into the cation concentration compartment (120), which is disposed adjacent the second electrode (106).

After the system (100) has operated in the electrodialysis mode for a first time period, the polarities of the electrodes (104 and 106) are reversed and the system (100) transitions to the electrolysis mode. FIG. 1B illustrates the system (100) under operation in electrolysis mode. As shown, the polarities of electrodes (104 and 106) are reversed such that the first electrode (104) is now negatively charged and the second electrode (106) is now positively charged.

As shown, the first electrode (104) includes a catalyst portion (102) connected and/or integrated thereto. The catalyst portion (102) incorporates one or more catalysts configured to provide conversion of the pollutant(s) that concentrate in the anion concentration compartment (118) to environmentally benign, less harmful, and/or value-added products. Continuing with the example of nitrate, nitrate concentrated in the anion concentration compartment (118) is reduced to less harmful or value-added nitrogen products such as nitrite, ammonia/ammonium, and/or nitrogen gas. Corresponding oxidation reactions may occur at the second electrode (106) (e.g., water splitting).

FIGS. 1A and 1B illustrate embodiments operated under low-pH or substantially neutral-pH conditions, in which nitrate electroreduction may favor formation of nitrite, ammonia, ammonium, or combinations thereof. In contrast, FIGS. 1C and 1D illustrate embodiments operated under elevated-pH conditions, where the electrochemical environment shifts the nitrate reduction pathway toward formation of nitrogen gas.

A hybrid electrodialysis and electrolysis system such as illustrated beneficially combines the functions of pollutant removal and pollutant conversion into a single unit/system. This improves operational and space efficiencies as compared to using a dedicated electrodialysis system and a separate, downstream electrolysis system for denitrification. Moreover, because electrolytic energy efficiency and electrolytic rates are proportional to the localized concentration of the target pollutant, the pre-concentration of the pollutant in the direct vicinity of the catalyst portion (102) beneficially enables effective and efficient conversion within the same unit/system.

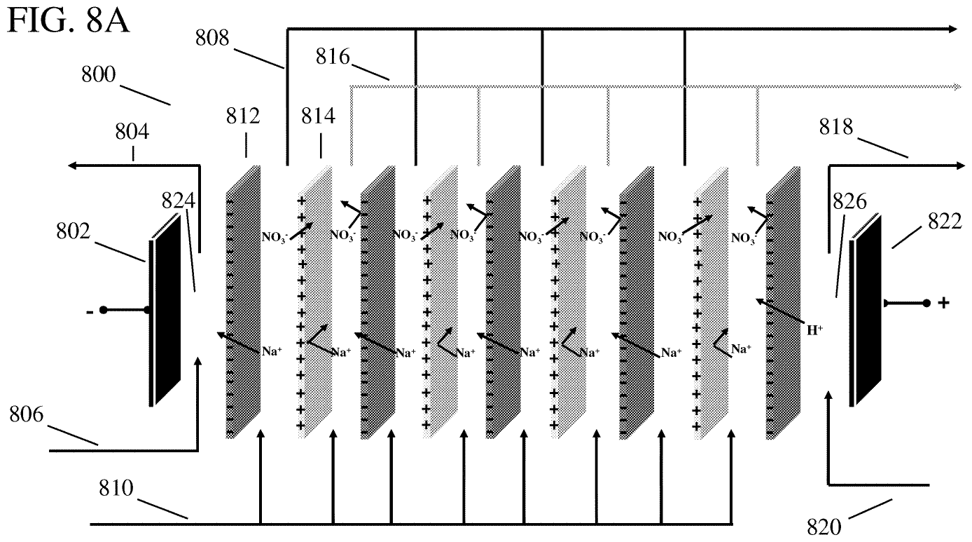

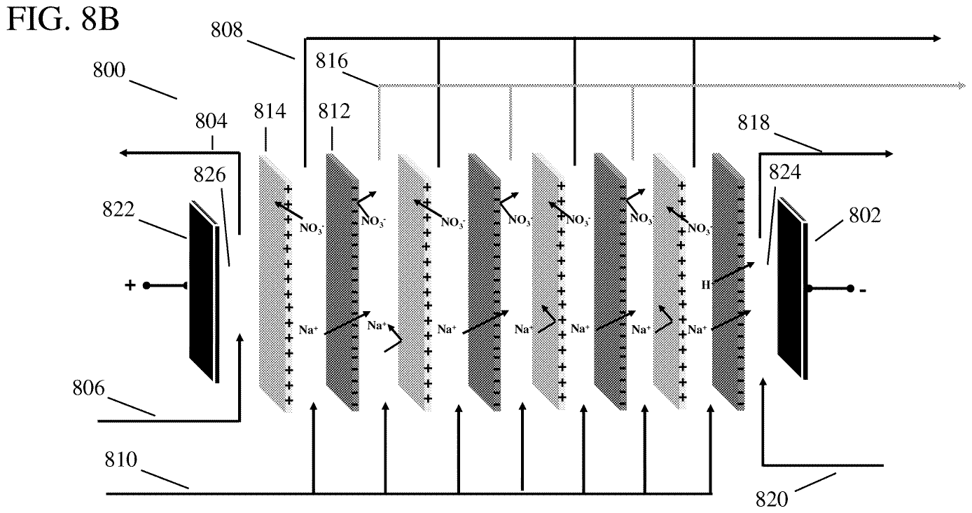

FIGS. 8A and 8B illustrate a hybrid electrodialysis and electrolysis system (800), according to another embodiment. The system (800) utilizes a plurality of ordered and repeating cation exchange membrane (812) and anion exchange membrane (814) pairs positioned between a first electrode (822) and second electrode (802). FIG. 8A illustrates one embodiment in which the first electrode compartment (826) adjacent to the first electrode (822) is defined between a cation exchange membrane (812) and the first electrode (822). In some embodiments, the first electrode (822) may be the only electrode adjacent to or in direct contact with the first electrode compartment (826). FIG. 8B illustrates one embodiment in which the polarity is reversed and the first electrode compartment (826) is defined between an anion exchange membrane (814) and the first electrode (822). In FIG. 8B, a second electrode compartment (824) is defined between a cation exchange membrane (812) and the second electrode (802). In some embodiments, the second electrode (802) may be the only electrode adjacent to or in direct contact with the second electrode compartment (824). Both the second electrode compartment (824) and the first electrode compartment (826) are configured to receive inlet flows (820 and 806, respectively) and to output outlet flows (818 and 804, respectively). The plurality of cation exchange membranes (812) and anion exchange membranes (814) form a plurality of central compartments, which form alternating concentrating and diluting compartments. Each central compartment is configured to receive a feed inlet flow (810) and output an outlet flow. The concentrating compartments output an effluent outlet flow (816) and the diluting compartments output a diluate outlet flow (808).

In certain embodiments, the alternating concentrating and diluting compartments are configured such that purified water and nitrate-rich concentrate streams are continuously produced regardless of electrode polarity, and with or without the need for polarity reversal. The nitrate-rich concentrate stream effluent may be selectively directed to whichever electrode is operating cathodically at a given time such that nitrate electroreduction may occur at either the first electrode (822) or the second electrode (802) depending on the applied polarity. In certain embodiments, one or both electrodes comprise porous flow-through scaffold electrodes, optionally comprising copper-coated nickel, titanium, or combinations thereof, configured to receive flow through the porous electrode structure. In some embodiments, both the first electrode and second electrode comprise electrically conductive 3-dimensional macroporous open-cell scaffolds having an electrochemically active surface area greater than 10 times their compartment-exposed geometric area. The scaffold surfaces may comprise or be coated with a copper catalyst and may further comprise a material configured to passivate oxidation of the copper catalyst coating when the first electrode operates as an anode. In certain embodiments, the scaffolds comprise nickel, titanium, or combinations thereof. In some embodiments, the scaffolds may further be in electrical contact with a porous electrically conductive screen, mesh, or other porous material configured to act as an electric current distributor. For multi-compartment cells in that way, electrodialysis and electrolytic reduction can occur with a catalytically effective single first electrode without polarity reversal or also for the embodiment with polarity reversal where the second electrode is also constructed with an electro-reductive catalyst.

Upon polarity reversal, the anodic and cathodic functions of the electrodes may reverse, and the dilute and concentrate flow paths may correspondingly reverse while maintaining continued electrodialysis purification and nitrate electroreduction operation. In certain embodiments, the membranes adjacent to the electrode compartments may independently comprise either anion exchange membranes or cation exchange membranes. In some embodiments, the ion exchange membranes adjacent to either of the first or second electrodes may be semipermeable to anions or semipermeable to cations. Where an anion exchange membrane is positioned adjacent to an electrode compartment, nitrate migrating across the membrane during polarity reversal may be recaptured in an adjacent concentrate compartment and recycled back to the electrode feed stream.

In certain embodiments, oxygen evolution occurs at whichever electrode is functioning anodically, and oxygen-containing streams may optionally be degassed prior to recirculation. The system may operate under low-pH, substantially neutral-pH, or elevated-pH conditions, where pH, applied voltage, catalytic material composition, electrode surface area, and feed composition influence nitrate electroreduction selectivity and formation of nitrogen-containing products. In certain embodiments, elevated cathodic overpotentials may increasingly favor hydrogen evolution reactions, thereby reducing nitrate electroreduction efficiency. Accordingly, high-surface-area porous scaffold electrodes may reduce electrode voltage drop and increase the proportion of electrical current utilized for nitrate electroreduction relative to hydrogen generation.

In additional embodiments, ammonia and/or ammonium products may be generated during nitrate electroreduction, and release of ammonia gas may be controlled through adjustment of pH, voltage, and operating conditions. Depending on nitrate concentration, desired purification level, number of concentrating and diluting compartments, electrode area, applied current, desired nitrogen-containing products, and operating mode, the current requirements for water purification and nitrate electroreduction may vary over time. In certain embodiments, concentrate holding tanks, recycle reservoirs, or dedicated electroreduction operating modes may be used to buffer variations between purification demand and nitrate electroreduction demand and to rebalance system operation. In embodiments where the feedwater or feedstock already comprise a concentrated nitrate-containing, nitrite-containing, ammonia-containing, ammonium-containing, or mixed nitrogen-containing stream, the dedicated electroreduction operating mode may be used as the primary operating mode without a preceding electrodialysis concentrating step.

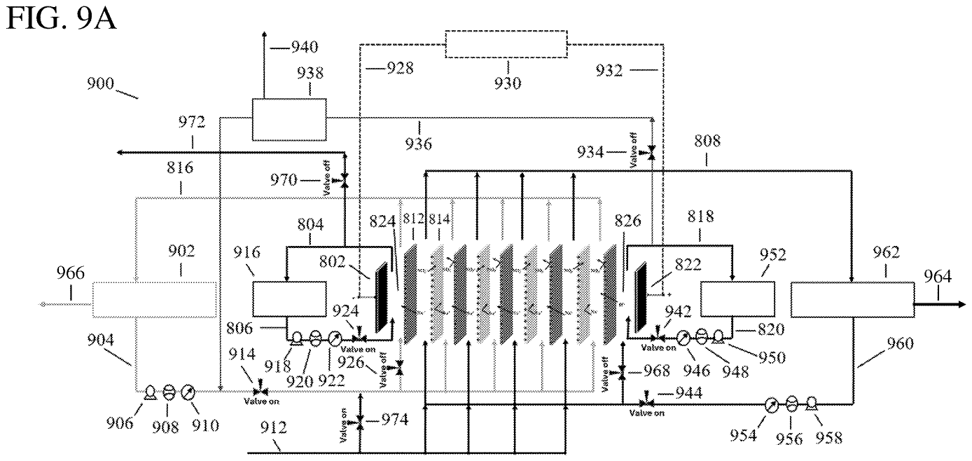

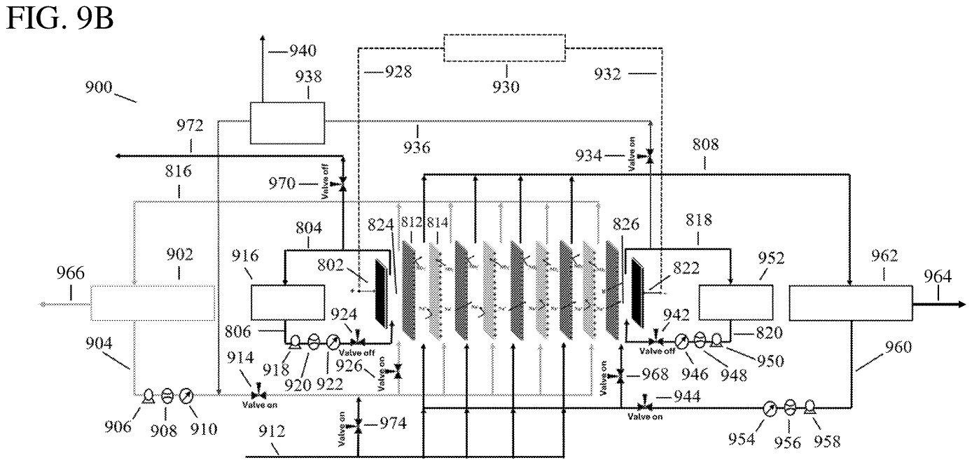

FIG. 9A expands upon the system description in FIG. 8A and illustrates an electrodialysis mode, according to one embodiment. The system (900) includes a power supply (930), which provides a cathode electrical connection (928) and an anode electrical connection (932). In FIG. 9A, the first electrode compartment (826) and second electrode compartment (824) are configured to receive an inlet recirculating flow (820 and 806, respectively) and output an outlet flow (818 and 804, respectively). Said electrode stream recirculating flows may be replenished from any of the other streams such as the feedwater inlet stream (912) through a valve (968), the concentrate inlet stream (904) through a valve (926) or the effluent from the other opposing electrode stream (804 or 818). In the electrodialysis mode, these inlet and outlet flows are fluidly connected to electrode rinse systems (916 and 952, respectively). In some embodiments, the system may further comprise fluid control valves in fluid communication with each of the first and second electrode compartments inlets and outlets. The electrode rinse (952) of the anion concentrating compartment is fluidly connected to a pump (950), flowmeter (948), pressure gauge (946), and valve (942) to provide flow rate controls on the system (900). The electrode rinse (916 or 952) of the compartments may, for example, be fluidly connected to a pump (918 or 950), flowmeter (920 or 948), pressure gauge (922 or 946), and valve (924 or 942) to provide controls on the system (900). Other controls such as pH control (not shown) may also be utilized.

The system (900) includes an optional concentrate tank (902) fed by the effluent outlet (816) of the concentrating compartments and an optional diluate tank (962) fed by the diluate outlet (808) of the diluting compartments. The nitrate-enriched effluent outlet (816) may be collected in the concentrate tank (902) or recirculated via a concentrate recycle stream (904) until it reaches a desired nitrate concentration. Concentrating nitrate prior to electrochemical reduction can improve the efficiency of the reduction step by increasing the local nitrate concentration at the cathodic catalyst surface. This can increase nitrate mass-transfer availability, improve catalyst utilization, reduce treatment volume, and allow the electrochemical reduction stage to be performed on a smaller volume of nitrate-enriched liquid instead of the full feedwater volume. The concentrate recycle stream is in fluid communication with a pump (906), flowmeter (908), pressure gauge (910), and valve (914) to provide controls on the system (900). The diluate outlet (808) may be collected in the diluate tank (962) or recirculated via a diluate recycle stream (960) until it reaches a desired target nitrate removal limit. The diluate recycle stream is in fluid communication with a pump (958), flowmeter (956), pressure gauge (954), and valve (944) to provide controls on the system (900). The diluate recycle stream (960) may also be combined with an incoming feedwater stream (912). The concentrate tank (902) and diluate tank (962) are both configured to output a product stream (966 and 964, respectively), if desired.

The system (900) is configured to allow the diluate recycle stream (960) to feed the first electrode compartment (826). A valve (968) controls the introduction of the diluate recycle stream (960) into the first electrode compartment (826). The system is further configured to allow the outlet stream (818) of the first electrode compartment (826) to be introduced to the second electrode compartment (824). A valve (934) is positioned to direct the diverted outlet stream (936) toward a degasifier unit (938). The degasifier (938) is configured to release an outlet stream (940) of gaseous byproducts within the diverted outlet stream (936). The diverted outlet stream (936) is merged with the outlet stream (904) of the concentrate tank (902). This merged stream may also be combined with the incoming feedwater stream (912) as controlled by a valve (974). A valve (926) controls the introduction of this merged stream into the second electrode compartment (824). The outlet stream (804) of the second electrode compartment (824) is configured to outlet a product stream (972). A valve (970) controls this product stream (972). The valve (968) of the diluate recycle stream (960), the valve (934) of the diverted outlet stream (936), the valve (926) of the merged stream, and the valve (970) of the product stream (972) are closed during operation in an electrodialysis mode.

FIG. 9B illustrates the same system (900) as FIG. 9A in an electrolysis mode, according to one embodiment. Polarity of the electrodes are reversed such that the first electrode becomes an electro-reductive cathode. The four valves that were closed during operation in an electrodialysis mode, the valve (968) of the diluate recycle stream (960), the valve (934) of the diverted outlet stream of the cation concentrating compartment (936), the valve (926) of the merged diverted outlet stream (936) and concentrate tank outlet stream (904), and the valve (970) of the product stream (972), are opened for operation in an electrolysis mode. The valve (924) of the inlet stream (806) to the cation concentrating compartment (824) from the electrode rinse system (916) is closed for operation in an electrolysis mode.

In some embodiments, exemplified above, the system includes one or more valves, pumps, manifolds, flow controllers, or other fluid-control components configured to switch the flow path of the nitrate-enriched concentrate after the electrodialysis mode. During the electrodialysis mode, the nitrate-enriched concentrate may be collected from or circulated as feed to the first electrode compartment. After sufficient nitrate removal from the feedwater and/or sufficient nitrate concentration in the concentrate stream, the flow path may be changed so that the nitrate-enriched concentrate is directed into or recirculated through the chamber that operates as a cathodic chamber during the electrolysis mode. In this cathodic chamber, nitrate reduction takes place.

In certain embodiments, the same physical compartment may function as an anion concentrating compartment during the electrodialysis mode and as a cathodic nitrate-reduction compartment during the electrolysis mode after polarity reversal. In other embodiments, the nitrate-enriched concentrate may be collected from an anion concentrating compartment during electrodialysis and then transferred to a separate cathodic reduction compartment during electrolysis. In still other embodiments, a valve network may selectively connect the outlet of the nitrate concentrating compartment to the inlet of the cathodic chamber so that the nitrate-enriched concentrate is recirculated through the cathodic chamber in a closed-loop or semi-closed-loop flow path.

The flow-switching operation may allow the system to decouple nitrate separation from nitrate conversion. During the first stage, the system primarily performs electrodialytic separation, producing a treated diluate stream and a nitrate-enriched concentrate stream. During the second stage, the system primarily performs electrochemical nitrate reduction on the smaller-volume nitrate-enriched concentrate. This staged operation can reduce the total volume subjected to electrolysis, increase the concentration of nitrate available for reduction, and improve energy efficiency relative to direct electrolysis of the entire feedwater volume.

In certain embodiments, the system operates cyclically. A first cycle includes feeding nitrate-containing water into the electrodialysis cell, collecting nitrate-depleted diluate, and collecting or recirculating nitrate-enriched concentrate. A second cycle includes switching the flow path of the nitrate-enriched concentrate and reversing the electrode polarity so that the nitrate-enriched concentrate circulates through the cathodic chamber where nitrate reduction occurs. After completion of the electrolysis cycle, the system may return to the electrodialysis mode to process additional feedwater. The cycles may be performed batchwise, semi-continuously, or continuously using multiple compartments, tanks, or parallel cell stacks.

In some embodiments, the nitrate-enriched concentrate is stored in an intermediate concentrate tank between the electrodialysis mode and the electrolysis mode. The intermediate concentrate tank may allow multiple electrodialysis concentration cycles to generate a sufficiently concentrated nitrate stream before electrochemical reduction is initiated. In other embodiments, the nitrate-enriched concentrate is continuously or intermittently withdrawn from a concentrating compartment and directed to a cathodic reduction loop. The cathodic reduction loop may include the cathodic chamber, a recirculation pump, a product tank, a gas-liquid separator, a pH-adjustment unit, an ammonia-recovery unit, or combinations thereof.

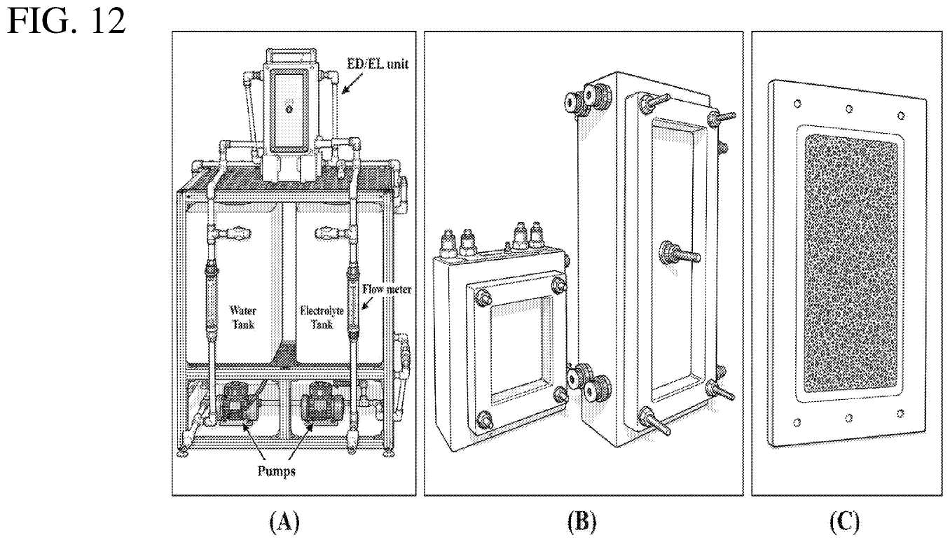

FIGS. 12A-C illustrate an electrodialysis and electrolysis unit, reactor housings, and catalyst-coated 3D electrodes suitable for nitrate removal and nitrate conversion. FIG. 12A shows an exemplary electrodialysis and electrolysis system integrated into a demonstration setup. The system may include an electrodialysis and electrolysis unit fluidly connected to one or more water tanks, electrolyte tanks, pumps, flow meters, tubing, and associated fittings. In some embodiments, the pumps may be configured to circulate a nitrate-containing aqueous stream and/or electrolyte through the electrodialysis and electrolysis unit. The flow meters may be used to monitor or control the flow rate of the process streams during electrodialysis operation, electrolysis operation, or sequential electrodialysis and electrolysis operation.

FIG. 12B shows exemplary reactor housings for hybrid electrodialysis and electrolysis units having different active areas. In some embodiments, the hybrid units may include a larger-area unit having an active area of about 1600 cm² and a smaller-area unit having an active area of about 64 cm². The units may be originally configured as electrodialysis units, such as commercially available electrodialysis units from PCCell GmbH, and may be re-engineered or modified for use in the presently disclosed hybrid electrodialysis and electrolysis system. The modified units may be configured to house ion-exchange membranes, spacers, gaskets, flow channels, and catalyst-coated electrodes for nitrate removal and/or nitrate conversion.

FIG. 12C shows an exemplary three-dimensional nickel foam electrode sized and configured for integration into the 1600 cm² hybrid unit. In some embodiments, the nickel foam electrode may be coated with one or more nitrate reduction catalysts, including copper-containing catalysts, metal nanoparticles, or other electrocatalytic materials. The three-dimensional porous structure of the nickel foam may provide increased surface area, improved electrolyte contact, and enhanced catalyst loading relative to planar electrodes. The catalyst-coated nickel foam electrode may be cut, shaped, or otherwise dimensioned to fit within the corresponding large-area or small-area hybrid electrodialysis and electrolysis unit.

Together, FIGS. 12A-C demonstrate that commercially available electrodialysis hardware may be adapted into a hybrid electrodialysis and electrolysis platform by integrating fluid handling components, modified reactor housings, and catalyst-coated three-dimensional electrodes for nitrate removal from aqueous streams and subsequent electrochemical conversion of nitrate to ammonium, nitrogen, or other nitrogen-containing products.

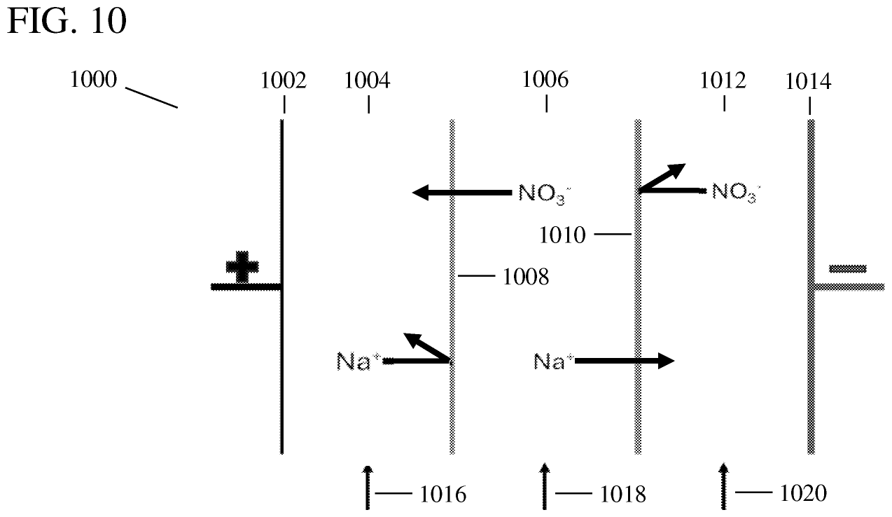

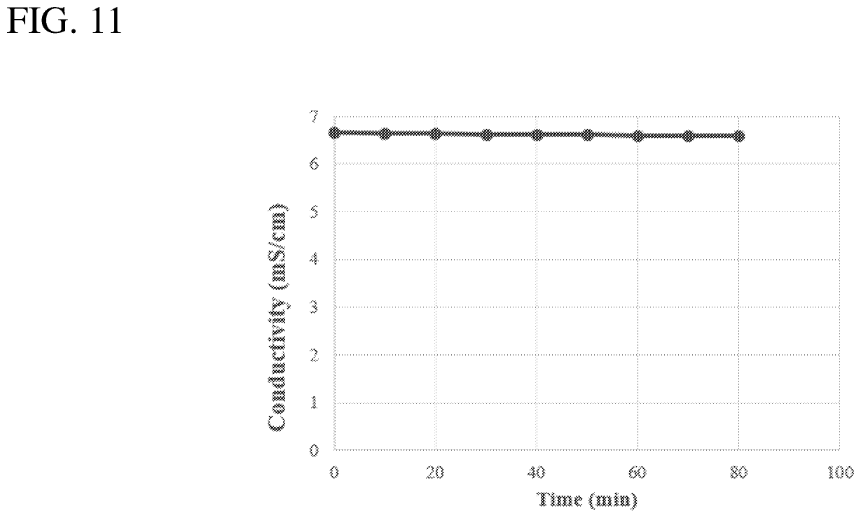

It is noted that the systems described herein are fundamentally distinct from capacitive deionization (CapDI) systems and are not configured to operate via capacitive ion adsorption. In CapDI systems, ions are removed from solution by electrostatic adsorption onto high surface area electrodes, which is generally reversible and does not inherently provide chemical conversion of the adsorbed species. In contrast, the present disclosure utilizes ion-selective membranes to drive directional ion transport and concentration into defined compartments, followed by electrochemical conversion at catalytically active electrode surfaces. Unlike CapDI, the electrodes of the present invention may feature insubstantial adsorption of counterions on the wetted surfaces of the electrode material. This feature avoids the well-known drawback of CapDI for water treatment when operating at elevated solute concentrations involving release of concentrated coions associated with the liquid double layer that forms within the porous structure of CapDI electrodes when CapDI electrode static charge is reversed or released. This non-adsorptive feature of the present invention disclosed herein despite the use of high surface area porous electrodes, along with the use of anion and cation selective exchange membranes and polarity-switching operation enables both selective ion migration and subsequent reactions that are not achievable in conventional CapDI architectures. Further, the feedwater purification and electroreduction can, in certain embodiments, be accomplished even without the need for polarity reversal. This distinction of non-adsorption was demonstrated experimentally in Example 7, which evaluated an electro-reductive catalytic electrode as described herein, but in a capacitive deionization configuration under otherwise comparable conditions. As described in Example 7 and FIGS. 10 and 11, the CapDI configuration exhibited negligible nitrate removal and/or conversion, thereby confirming that by use of the electrodes disclosed herein avoids the drawbacks of use of CapDI.

### Nitrate Reduction Pathways

In the embodiments as described herein, the electrolysis mode may be operated to reduce nitrate to one or more nitrogen-containing reduction products. The product distribution may be controlled by one or more of catalyst composition, electrode substrate, applied potential, current density, electrolyte pH, nitrate concentration, nitrite concentration, residence time, mass-transfer conditions, membrane configuration, and the relative rates of competing hydrogen evolution and water oxidation reactions. Products of nitrate electroreduction may include, without limitation, nitrite (NO₂⁻), nitric oxide (NO), nitrous oxide (N₂O), nitrogen gas (N₂), ammonia (NH₃), ammonium (NH₄⁺), hydroxylamine, hydrazine, and combinations thereof. In ammonia-recovery embodiments, at least a portion of nitrate is reduced to ammonia and/or ammonium, and residual nitrate may remain in the product solution as an additional nitrogen-containing fertilizer component.

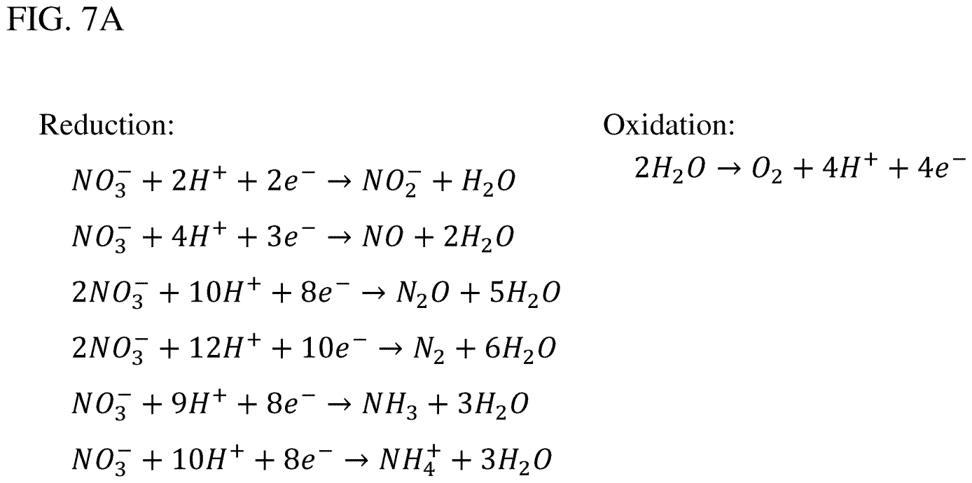

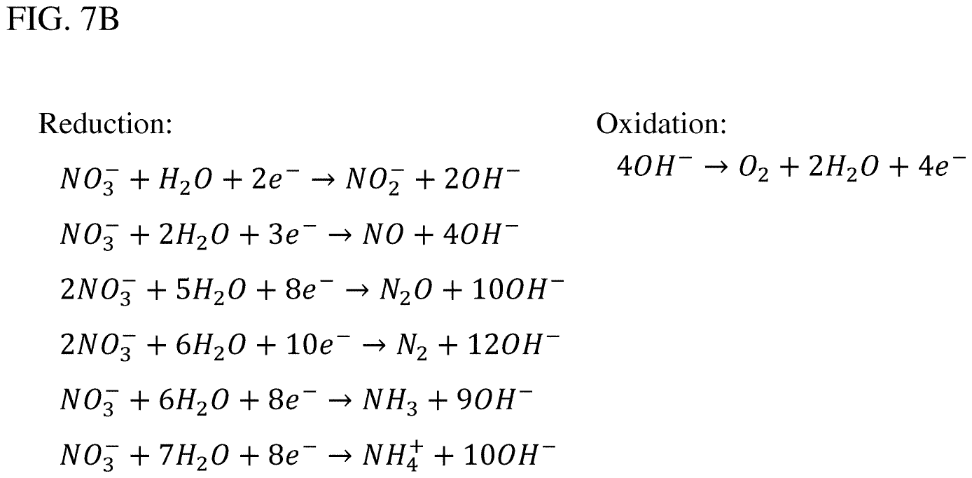

FIG. 7A provides representative reduction and oxidation half-reactions that may occur under acidic conditions. FIG. 7B provides representative reduction and oxidation half-reactions that may occur under alkaline conditions. The reactions illustrated in FIGS. 7A and 7B are representative electrochemical half-reactions and are not intended to limit the mechanism or actual product pathway, which may include intermediates, sequential conversion through nitrite, and parallel reactions. Specifically, as defined herein, the term “nitrogen-based anions” means a dissolved solute or a chemical intermediate of a dissolved solute comprising the element nitrogen that may be directly or indirectly electro-reduced as a result of electron transfer at an electrode. Depending on pH, ammonia may be present predominantly as NH₃, NH₄⁺, or a mixture thereof. In alkaline electrolyte, ammonia may be generated as dissolved NH₃, while in neutral or acidic product solutions at least a portion of ammonia may be protonated to NH₄⁺. Corresponding oxidation reactions at the opposing electrode may include oxygen evolution from water or hydroxide. Where chloride, bromide, organic species, or other oxidizable constituents are present in the feedwater or electrode compartment, competing oxidation reactions may occur at the opposing electrode. In preferred embodiments, operating conditions and anode catalyst materials are selected to favor oxygen evolution and suppress undesired oxidation products.

Electrolyte pH provides a particularly powerful and tunable control parameter for directing product formation and distribution during nitrate electroreduction. By adjusting the proton activity of the system, the reaction pathway may be biased toward distinct intermediates and end products, thereby enabling selective formation of desired nitrogen-containing species and control over their relative ratios. In general, more acidic environments tend to favor partial reduction pathways, resulting in increased formation of NO₂ and reduced nitrogen species such as ammonia/ammonium, whereas more alkaline conditions tend to promote further reduction and coupling pathways leading to increased formation of N₂. In certain embodiments the recirculation of acidic or basic products formed by water hydrolysis at the electrode compartments may be blended with the feed to the reductive electrode to manage the pH of the reductive electrode stream.

### Additional Electrode & Catalyst Details

The following features can be incorporated individually or in combination with one or more of the other features into the hybrid electrodialysis and electrolysis systems described herein.

Various substrates may be utilized to form one or both electrodes of the hybrid electrodialysis and electrolysis system. Suitable electrode substate materials include graphite, nickel, copper, iron, titanium, polytetrafluoroethylene (PTFE) membrane materials, carbon (e.g., activated carbon, carbon nanotubes), transparent conductive oxides, and combinations thereof. The form of the substrate is preferably configured to provide a high surface area. For example, the substrate may be configured as a mesh, felt, foamed structure, or other porous material. In certain embodiments, the electrode comprises a scaffold-type porous structure that is plated or coated with copper to provide both high electrical conductivity and catalytic activity for nitrate reduction. In some embodiments, both the first electrode and the second electrode may comprise a copper catalyst. In further embodiments, one or both electrodes may comprise an electrically conductive chemically inert scaffold material comprising a coating of a selective electro-reductive catalyst for nitrate reduction. In systems where only one electrode includes a catalytic portion, the counter electrode may be formed from a simple conductive material such as stainless steel.

The porous scaffold electrode may be configured to permit flow-through operation in which water passes through the internal pore structure of the electrode, thereby significantly increasing contact between the fluid and the catalytically active surfaces. This flow-through configuration increases mass transport rates and accelerates electrochemical reaction kinetics as compared to planar electrode configurations. In some embodiments, the scaffold may be in electrical contact with a porous electrically conductive screen, mesh, or other porous material configured to act as an electric current distributor.

Where a porous substrate is utilized, the pores preferably have an average diameter of about 100 μm to about 1 mm, or more preferably about 200 μm to about 800 μm, or about 300 μm to about 700 μm, or about 350 μm to about 650 μm, or about 400 μm to about 600 μm, such as about 500 μm, or within a range having any two of the foregoing values as endpoints. A porous electrode substrate with an average pore diameter within the foregoing values was found to optimally balance sufficient charge transfer capabilities with high surface areas and ability to effectively integrate catalyst material therein.

Further, when a porous substrate is utilized, the substrate is preferably configured with a pore density of about 20 to about 200 pores per square inch (ppi), or more preferably about 25 ppi to about 150 ppi, or about 30 ppi to about 120 ppi, or about 35 ppi to about 100 ppi, or about 40 ppi to about 80 ppi, or about 50 ppi to about 70 ppi, such as about 60 ppi, or a pore density within a range defined by any two of the foregoing values. A substrate with a pore density within the foregoing values was found to provide sufficiently low charge transfer resistance while also providing sufficiently high electrochemically active surface area.

In additional embodiments, one or both electrodes comprise titanium, nickel, or combinations thereof. The titanium or nickel may be provided as a plate, foil, mesh, screen, felt, foam, expanded metal, perforated sheet, porous body, three-dimensional macroporous open-cell scaffold, current collector, or support structure. The electrode material may serve as an electrically conductive scaffold or current collector upon which a catalytic material is deposited, coated, plated, grown, embedded, or otherwise associated.

Titanium may be used where corrosion resistance, chemical stability, mechanical strength, and compatibility with oxidizing or alkaline environments are desired. In some embodiments, titanium is used as an inert support for a nitrate-reduction catalyst, including copper, copper oxide, copper hydroxide, copper alloy, copper-containing nanoparticles, or a copper-containing composite. In other embodiments, titanium is used as a current collector or structural support for an oxidation catalyst at the counter electrode.

Nickel may be used as a conductive substrate, foam, mesh, felt, or current collector. Nickel substrates provide high surface area, mechanical robustness, and compatibility with alkaline electrochemical systems. A nickel substrate may act as a passivating support and may be coated with a nitrate-reduction catalyst, including a copper-containing catalyst, or may itself participate in catalysis depending on operating potential and surface composition. In additional embodiments, the second electrode comprises nickel, nickel oxide, nickel hydroxide, nickel oxyhydroxide, nickel-iron oxide, nickel-iron hydroxide, nickel-iron oxyhydroxide, or combinations thereof as an oxidation catalyst for water or hydroxide oxidation.

The catalyst associated with one or more of the electrodes to form the catalyst portion(s) may be provided as nanoparticles that are embedded or otherwise incorporated into the corresponding electrodes. For example, where the electrode substrate is formed as a porous material, catalyst nanoparticles may be distributed and embedded within the porous surfaces of the substrate to take advantage of the increased surface area provided by the porous structure.

Suitable catalyst materials for nitrate reduction (but which may be additionally or alternatively used for other pollutants) include Cu, Pd—Cu, Ni, Zn—Cu, Pt, Rh, Pt—Rh, Pd—Cu, Pt—Cu, Rh—Cu, Ir—Cu, Sn—Pt, Sn—Pd—Au, Pd—Sn, Pd—Cu, Pd—In, Fe—Ni, Pd, Ag, Au, Ru, Ir, metal oxides, metal hydroxides, and combinations thereof.

Exemplary electrode substrates and catalysts, and certain exemplary combinations of electrode substrates and catalysts that may be utilized together in a hybrid electrodialysis and electrolysis system, are provided below in Table 1:

TABLE 1

| Substrate material | Catalyst |
|---|---|
| Graphite | Cu and Pd—Cu |
| Ni | Ni particles |
| | Zn—Cu Alloy |
| Cu | Cu |
| PTFE Membrane | Pt |
| PTFE Membrane | Rh |
| PTFE Membrane | Pt—Rh alloy |
| Activated Carbon | Pd—Cu, Pt—Cu, Rh—Cu, and Ir—Cu |
| | Sn—Pt, and Sn—Pd—Au |
| Graphite | Pt |
| Ni | Cu |
| Cu | Cu |
| Ni Foam | Cu |
| ITO | Pd—Sn |
| Carbon Nanotube (CNT) | Pd—Cu |
| CNT-TiO2 | Pd—Cu |
| Lignocellulose | Pd—In |
| Activated Carbon felt | Pd—Cu |
| Fe | Fe |
| Fe | Pd |
| Fe | Ag |

Catalyst nanoparticles may be loaded onto the electrode substrate using a variety of integration or deposition methods known in the art. In some embodiments, electrodeposition is utilized to deposit the catalyst nanoparticles. In some embodiments where a multi-metallic catalyst is utilized, each metal may be electrodeposited using a co-electrodeposition technique. Alternatively, a galvanic displacement technique may be utilized wherein a base metal (having a relatively higher oxidation potential) is first deposited on the substrate, and subsequently a second metal (having a relatively lower oxidation potential) is introduced to galvanically displace the first metal. The mass loading of catalyst nanoparticles to the electrode substrate may range from about 0.05 mg_{catalyst}/cm² to about 0.25 or up to about 0.5 mg_{catalyst}/cm².

The size of the catalyst nanoparticles integrated with the electrode substrate may vary according to particular application needs. Catalyst nanoparticles may range in average size from about 2 nm to about 500 nm, more typically about 10 nm to about 300 nm, or about 15 nm to about 200 nm, or about 20 nm to about 100 nm, or may have an average size within a range with endpoints defined by any two of the foregoing values. Systems utilizing catalyst nanoparticles within the foregoing size ranges were found to provide effective surface area and catalytic activity while also balancing the ability to effectively integrate the nanoparticles into the pores of the electrode substrate.

In embodiments for nitrate-to-ammonia conversion, the nitrate-reduction electrode includes a non-precious metal catalyst comprising copper. The copper catalyst may include metallic copper, copper oxide, copper hydroxide, copper oxyhydroxide, copper nitride, copper alloy, copper-containing composite, copper nanoparticles, nanostructured copper, electrodeposited copper, chemically deposited copper, sputtered copper, plated copper, or combinations thereof. The copper catalyst may be supported on carbon, graphite, titanium, nickel, stainless steel, conductive polymer, conductive oxide, or another conductive scaffold.

Copper is particularly useful as a non-precious catalyst for nitrate electroreduction because it can activate nitrate and nitrite species and can promote multi-electron reduction pathways. The use of copper may reduce reliance on precious metals such as palladium, platinum, rhodium, iridium, ruthenium, gold, or silver. In some embodiments, the nitrate-reduction catalyst is substantially free of precious metals. In other embodiments, the copper catalyst includes a minor amount of one or more promoter metals or heteroatoms to modify selectivity, durability, conductivity, or resistance to poisoning.

In paired-electrode embodiments, the nitrate-reduction electrode comprises a copper-containing catalyst and the opposing oxidation electrode comprises a nickel-containing catalyst. For example, a cathode may comprise copper on a titanium or nickel scaffold, and an anode may comprise nickel foam, nickel mesh, nickel oxide, nickel hydroxide, nickel oxyhydroxide, nickel-iron oxide, nickel-iron hydroxide, nickel-iron oxyhydroxide, or combinations thereof. Such pairing enables a non-precious metal nitrate-reduction cathode and a non-precious metal oxygen-evolution anode in the electrolysis mode.

The cathodic chamber may include a nitrate-reduction electrode comprising a conductive substrate and a nitrate-reduction catalyst. The conductive substrate may comprise titanium, nickel, carbon, graphite, stainless steel, copper, or combinations thereof. In preferred embodiments, the cathodic nitrate-reduction catalyst comprises copper or a copper-containing catalyst. Copper is advantageous as a non-precious metal catalyst capable of promoting electrochemical nitrate reduction. In some embodiments, the copper catalyst is provided on a titanium scaffold, nickel scaffold, carbon scaffold, or another conductive substrate. In some embodiments, the copper catalyst is present as a nanoparticulate, porous, plated, electrodeposited, spray-coated, thermally treated, chemically deposited, or otherwise supported catalyst layer.

During the electrolysis mode, nitrate in the nitrate-enriched concentrate may be reduced at the cathodic electrode to one or more reduced nitrogen products. The reduced nitrogen products may include nitrite, nitric oxide, nitrous oxide, hydroxylamine, ammonia, ammonium, nitrogen gas, or combinations thereof. In fertilizer-recovery embodiments, at least a portion of the nitrate may be reduced to ammonia and/or ammonium. The resulting product stream may therefore comprise ammonia and/or ammonium and may further comprise residual nitrate that was not converted during the electrolysis mode. Such a product stream may be useful as a nitrogen-containing fertilizer solution or fertilizer precursor.

The opposing electrode during the electrolysis mode may function as an oxidation electrode. In some embodiments, the oxidation electrode comprises nickel, nickel foam, nickel mesh, nickel felt, nickel oxide, nickel hydroxide, nickel oxyhydroxide, nickel-iron oxide, nickel-iron hydroxide, nickel-iron oxyhydroxide, or combinations thereof. The nickel-containing oxidation electrode may catalyze an oxidation reaction, such as water oxidation, hydroxide oxidation, oxygen evolution, or another anodic reaction that balances the cathodic nitrate-reduction reaction. In certain embodiments, a nickel-containing oxidation catalyst is used on the anodic side while a copper-containing nitrate-reduction catalyst is used on the cathodic side, thereby providing a system that uses non-precious metal catalysts on both sides of the electrochemical cell. The nickel may also act to passivate copper to extend the life of a copper coated nickel electrode when said electrode is used as an anode.

### Product Streams Containing Both Nitrate and Ammonia

In some embodiments, the nitrate conversion process is not required to convert all nitrate to ammonia. A product stream may intentionally include both residual nitrate and produced ammonia/ammonium, such that the product stream contains more than one plant-available nitrogen form. For example, an aqueous fertilizer product may include ammonia, ammonium, nitrate, nitrite below a selected limit, dissolved salts, and water. The residual nitrate concentration may be selected based on product specification, safety requirements, fertilizer labeling, crop needs, downstream concentration, storage conditions, or regulatory requirements.

In fertilizer-production embodiments, the electrolysis mode may be controlled so that the nitrate-enriched concentrate is partially reduced, rather than fully reduced. Partial reduction may produce a nitrogen-containing aqueous product that includes ammonia and/or ammonium together with residual nitrate. Such a mixed nitrate/ammonia product may be desirable where both nitrate nitrogen and ammoniacal nitrogen are useful in the final fertilizer formulation. In such embodiments, complete nitrate conversion is not required. Instead, the system may be operated to produce a selected nitrogen speciation profile, including a selected ratio of nitrate nitrogen to ammoniacal nitrogen.

In some embodiments, the aqueous fertilizer product comprises ammonia, ammonium, residual nitrate, and one or more counterions such as sodium, potassium, calcium, magnesium, chloride, sulfate, carbonate, bicarbonate, phosphate, or combinations thereof. The composition of the product may depend on the original feedwater chemistry, supporting electrolyte, membrane selectivity, pH, and operating conditions. The system may be operated to avoid drying or crystallization of ammonium nitrate-containing compositions when residual nitrate and ammonium are both present. In certain embodiments, the product is maintained as an aqueous solution and is not evaporated to dryness.

For dilute aqueous fertilizer embodiments, the product stream is maintained as a liquid and is not intentionally dried to form solid ammonium nitrate. The system may include controls to maintain water content, pH, temperature, storage compatibility, and impurity limits to inhibit crystallization, precipitation, or concentration of oxidizing nitrate salts. In some embodiments, residual nitrate in the product stream is about 10 ppm to about 100,000 ppm as NO₃, about 100 ppm to about 50,000 ppm as NO₃, about 1,000 ppm to about 10,000 ppm as NO₃, or within a range defined by any two of the foregoing values, while ammonia/ammonium is present as a recovered nitrogen product.

### Operating Parameters, Sensors, and Controls

The nitrate-to-ammonia process may be carried out under acidic, neutral, or alkaline conditions. In some embodiments, the catholyte is alkaline to suppress corrosion, improve conductivity, control ammonia speciation, or improve catalyst stability. In other embodiments, the product stream is adjusted to a pH suitable for ammonia retention as ammonium, fertilizer compatibility, storage, or downstream separation. The applied potential or current density may be selected to favor ammonia production over nitrogen gas, to favor nitrogen gas production over ammonia, or to control the ratio of ammonia to residual nitrate.

In some embodiments, the nitrate-enriched concentrate is recirculated through the cathodic chamber multiple times until a selected conversion target is reached. The selected conversion target may be based on nitrate conversion, ammonia production, ammonium production, nitrite concentration, nitrogen gas production, current efficiency, Faradaic efficiency, pH, conductivity, oxidation-reduction potential, total nitrogen concentration, or another process parameter. For example, the concentrate may be recirculated until at least 10%, at least 25%, at least 50%, at least 70%, at least 80%, at least 90%, or at least 95% of the nitrate in the concentrate is converted to ammonia and/or ammonium. Alternatively, the concentrate may be recirculated until the product stream reaches a desired ratio of nitrate to ammonia/ammonium for use as a fertilizer solution. In embodiments where the feedwater or feedstock is introduced directly into the electrolysis mode, the selected conversion target may be based on the initial concentration or ratio of nitrate, nitrite, ammonia, ammonium, and other nitrogen-containing species in the feedwater or feedstock, and the system may be operated to increase, decrease, or maintain a selected nitrate-to-ammonia/ammonium ratio.

The system may further include sensors and controls for pH, oxidation-reduction potential, nitrate, nitrite, ammonia, ammonium, conductivity, temperature, flow rate, pressure, gas evolution, and liquid level. Control logic may adjust polarity, residence time, flow path, current density, voltage, or recycle ratio to achieve a target nitrate conversion, target ammonia production rate, target nitrate/ammonia ratio, or target nitrite limit.

The system may further include sensors and controls configured to determine when to switch from the electrodialysis mode to the electrolysis mode. Suitable sensors may include nitrate sensors, conductivity sensors, pH sensors, oxidation-reduction potential sensors, ammonia sensors, ammonium sensors, nitrite sensors, flow sensors, pressure sensors, temperature sensors, current sensors, voltage sensors, or combinations thereof. A controller may receive signals from one or more such sensors and actuate one or more valves, pumps, polarity switches, or power-supply settings to change the system from the electrodialysis concentration mode to the cathodic nitrate-reduction mode.

### Exemplary Water Treatment Applications

The hybrid electrodialysis and electrolysis systems described herein may be utilized in a variety of water treatment applications. For nitrate removal and conversion applications, such systems can be installed as an edge-of-field installation for fields that are drained using tiles. The systems can then treat nitrate-laden waters prior to discharge from the field into surface waters. Systems can also be utilized to treat community water systems or to treat private water supplies (e.g., private groundwater wells). Presently, in the U.S., there are over 1,700 community drinking water systems with nitrate levels higher than 10 mg/L. Many private wells have nitrate levels above recommended health advisory levels, particularly in agricultural areas.

This staged electrodialysis/electrolysis operation is particularly advantageous for high-strength nitrate wastewaters, brines, ion-exchange regenerant streams, reverse-osmosis concentrates, industrial nitrate-containing wastewaters, semiconductor wastewater, metal-finishing wastewater, nitric-acid-containing wastewater, stainless-steel pickling wastewater, agricultural drainage, or other nitrate-containing streams. The ability to first concentrate nitrate and then convert the concentrate in a cathodic recirculation loop can reduce wastewater volume, lower treatment burden, and generate a recoverable nitrogen product.

Although many of the examples described herein relate to nitrate removal and conversion, the components and principles described herein may also be utilized for the removal and conversion of a wide variety of other chemical and/or biological contaminants/pollutants. A non-exhaustive list of such chemical contaminants includes nitrogen, bleach, salts, pesticides, metals, toxins produced by bacteria, nitrate (NO₃), chloride (Cl), chromium-6 (Cr-6), chromium-3 (Cr-6), copper (Cu), fluoride (F), iron (Fe), selenium (VI), boron, lithium (Li), sodium (Na), calcium (Ca), magnesium (Mg), zinc (Zn), arsenic (As), uranium (U), strontium (Sr), cadmium (Cd), cyanide (CN), nitrite (NO₂), phosphate, perfluorooctanoic acid (PFOA) and perfluorooctane sulfonate (PFOS), 1,1-dichloroethane, acetochlor, methyl bromide (bromomethane), metolachlor, nitrobenzene, 1,4-Dioxane, 1,2,3-trichloropropane, and chloroamine.

A non-exhaustive list of medicinal pollutants that may be removed from feedwater and converted using the systems described herein includes aspirin, codeine, cyclophosphamide, galaxolide, pentoxifylline, tonalide, triclosan, etofibrate, etofyllinclofibrat, flurbiprofen, ketoprofen, nadolol, tolfenamic acid, carbamazepine, diazepam, ibuprofen, paracetamol, phenazone, bezafibrate, clofibrate, diclofenac, fenoprofen, fenofibrate, femfibrozil, indomethacine, iopromide, mefenamic acid, metoprolol, naproxen, propranolol, propyphenazone, roxithromycin, salbutamol, sulfamethoxazole, doxycycline, estrone, hydrochlorothiazide, iopamidol, metronidazole, ofloxacin, enalapril, furazolidone, ifosfamide, ketorolac, methicillin, nafcillin, erythromycin, furosemide, iomeprol, lincomycin, methotrexate, norfloxacin, oleandomycin, simvastatin, sotalol, omeprazole, oxacillin, oxytetracycline, penicillin, pindolol, piroxicam, ranitidine, ronidazole, spiramycin, sulfacetamide, sulfadiazine, sulfadimethoxine, sulfadimidine, sulfaguanidine, sulfamethazine, sulfamethazine, sulfapyridine, sulfasalazine, sulfathiazine, tamoxifen, terbutaline, tetracycline, tilmicosin, trimethoprim, tylosin, virginiamycin, 17α-ethinylestradiol, 17β-estradiol, acetyl-sulfamethoxazole, amidotrizoic acid, aminopyridine, amoxycillin, anhydro-erythromycin, atenolol, bisoprolol, chloramphenicol, chlortetracycline, ciprofloxacin, clarithromycin, clenbuterol, cloxacillin, cyclophosphamide, dapsone, dimethyl diazepam, dextropropoxyphene, dicloxacillin, acetaminophen, and carbamazepine.

A non-exhaustive list of biological contaminants/pollutants that may be removed from feedwater and optionally destroyed using the systems described herein includes pathogenic microorganisms (viruses, bacteria, fungi, protozoa) and DNA and RNA contaminants. Common feedwater pathogens of concern include adenoviruses, caliciviruses, Campylobacter jejuni, enteroviruses, Escherichia coli, Helicobacter pylori, hepatitis A virus, Legionella pneumophila, Mycobacterium avium, Naegleria fowleri, and Salmonella enterica.

Table 2 provides a particular list of example contaminants that can be removed using the systems described herein, along with the present maximum contaminant level (MCL) as established by the U.S. Environmental Protection Agency (EPA), potential negative health effects associated with the contaminant, and common sources of the contaminant:

TABLE 2

| | MCL | | | |
|---|---|---|---|---|
| Contaminants | (mg/L) | | Potential health effects | Common source |
| Nitrate (NO3—) | 10 | | Infants could become | Runoff from fertilizer use; |
| | | | seriously ill and, if | leaching from septic tanks, |
| | | | untreated, may die. | sewage; erosion of natural |
| | | | (blue-baby syndrome) | deposits |
| Chloride (Cl) | 4 | | Eye/nose irritation; | Water additive used to |
| | | | stomach discomfort | control microbes |
| Chromium-6 | 0.1 | | Allergic dermatitis | Discharge from steel and |
| (Cr-6) | | | | pulp mills; erosion of |
| | | | | natural deposits |
| Chromium-3 | 0.1 | | Allergic dermatitis | Discharge from steel and |
| (Cr-6 | | | | pulp mills; erosion of |
| | | | | natural deposits |
| Copper (Cu) | 1.3 | | Short-term exposure: | Corrosion of household |
| | | | Gastrointestinal distress. | plumbing systems; erosion |
| | | | Long-term exposure: | of natural deposits |
| | | | Liver or kidney damage | |
| Fluoride (F) | 4 | | Bone disease (pain and | Water additive which |
| | | | tenderness of the bones); | promotes strong teeth; |
| | | | children may get mottled | erosion of natural deposits; |
| | | | teeth | discharge from fertilizer |
| | | | | and aluminum factories |
| Iron (Fe) | 0.3 | | | |
| Selenium (VI) | 0.05 | | Hair or fingernail loss; | Discharge from petroleum |
| | | | numbness in fingers or | and metal refineries; |
| | | | toes; circulatory | erosion of natural deposits; |
| | | | problems | discharge from mines |
| Boron | 0.5 | | | |
| Lithium | | | | |
| Sodium (Na) | 200 | | | |
| | (WHO limit) | | | |
| Calcium | | | | |
| Magnesium | | | | |
| Zinc | 5 | | | |
| Arsenic (As) | 0.01 | | Skin damage or | Erosion of natural |
| | | | problems with | deposits; runoff from |
| | | | circulatory systems, | orchards; runoff from |
| | | | increased risk of cancer | glass & electronics |
| | | | | production wastes |
| Uranium | 30 | μg/L | Increased risk of cancer, | Erosion of natural deposits |
| | | | kidney toxicity | |

| | | | |
|---|---|---|---|
| Strontium | | | |
| Cadmium | 0.005 | Kidney damage | Corrosion of galvanized |
| | | | pipes; erosion of natural |
| | | | deposits; discharge from |
| | | | metal refineries; runoff |
| | | | from waste batteries and |
| | | | paints |
| Cyanide | 0.2 | Nerve damage or thyroid | Discharge from steel/metal |
| | | problems | factories; discharge from |
| | | | plastic and fertilizer |
| | | | factories |
| Nitrite (NO₂⁻) | 1 | Similar to risks of nitrate | Runoff from fertilizer use; |
| | | | leaching from septic tanks, |
| | | | sewage; erosion of natural |
| | | | deposits |
| Phosphate | | | Runoff from fertilizer use; |
| | | | erosion of natural deposits |

### EXAMPLES

The function and advantages of these and other embodiments can be better understood from the following examples. These examples are intended to be illustrative in nature and are not considered to be limiting the scope of the invention.

### Example 1: Electrode Substrate Testing

Various carbon supports (carbon foam, carbon cloth, carbon felt; available from vendor Fuel Cell Store), and their electroactivity (charge transfer resistance) was characterized using AC EIS. The EIS for these carbon supports was recorded in 0.1 M H₂SO₄ at the open-circuit voltage in the frequency range of 1 MHz to 1 Hz with a 10-mV peak-to-peak sinusoidal potential perturbation. Saturated silver/silver chloride was used as the reference electrode and Pt wire as the counter electrode.

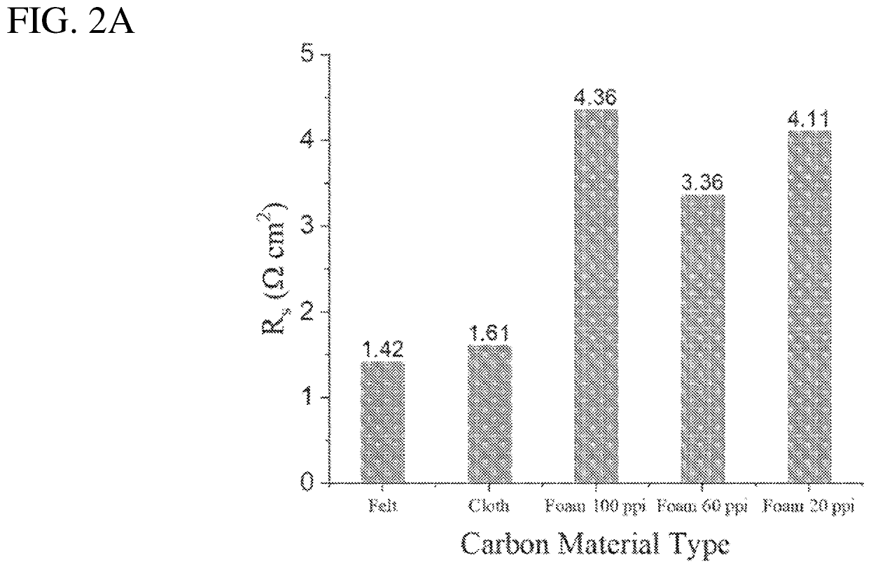

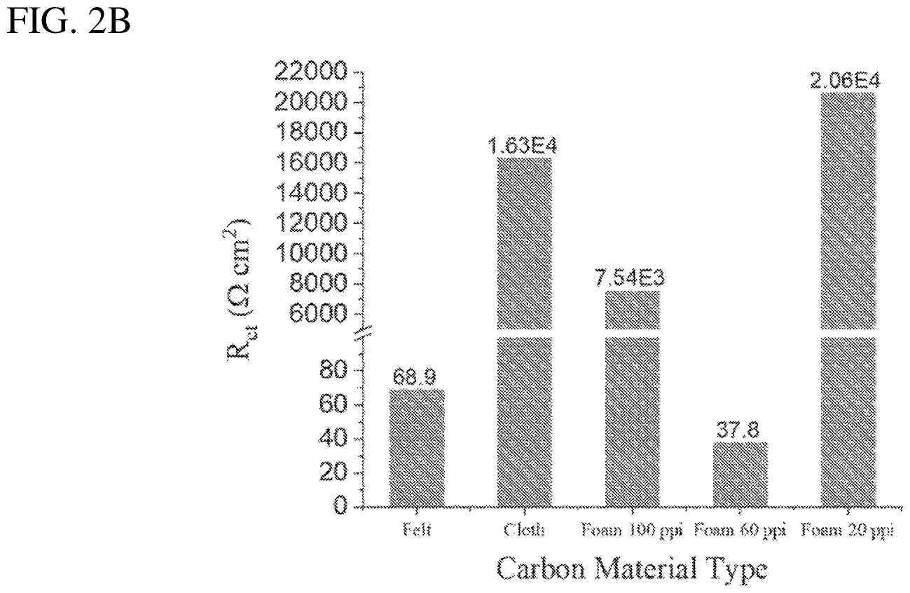

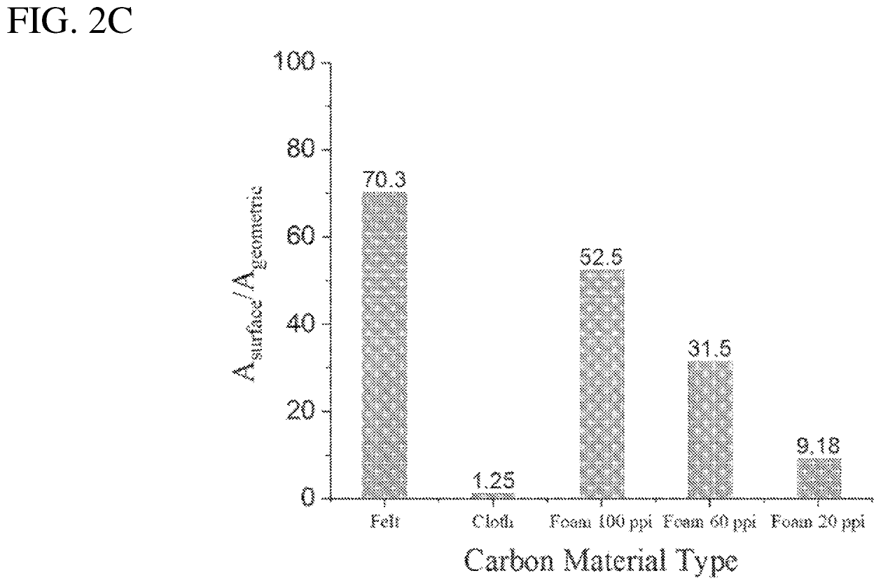

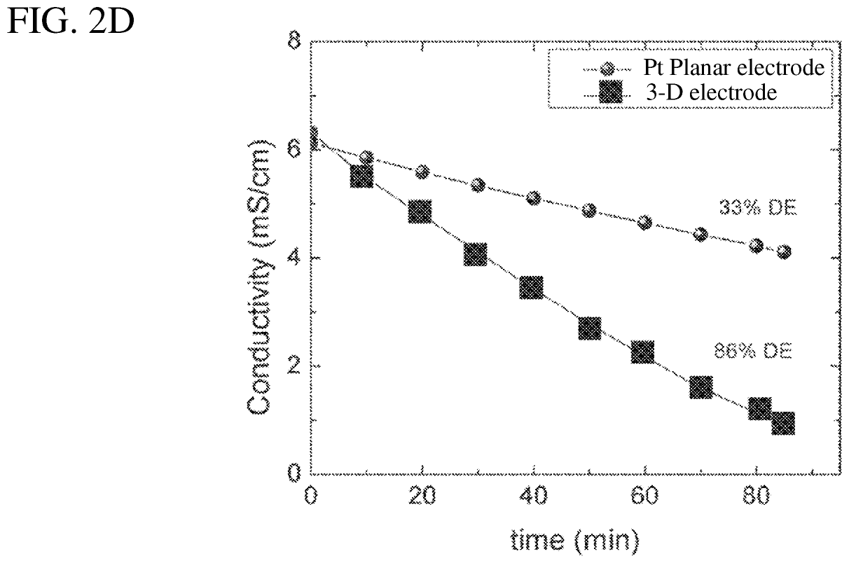

All carbon materials showed similar uncompensated series resistances (from 1.4 to 4.4-ohm cm²) as measured from the EIS, indicating the robustness of the measurement set-up (FIG. 2A). The charge transfer resistances were then determined from EIS for the carbon materials tested (FIG. 2B). Lower charge transfer resistance corresponds to a faster electron transfer rate (faster reaction rate), a key attribute for electrocatalysis. Our target was to achieve charge transfer resistances <100-ohm cm², suitable for effective electrolysis applications. Carbon felt and carbon foam with 60 ppi met this criterion. Another important characteristic of electroactive support is its electrochemically active surface area. For typical electrolysis applications, this value is preferred to be >10 when normalized with its geometric area. Carbon felt and carbon foam with 60 and 100 ppi met this criterion (FIG. 2C). Among the carbon materials tested, carbon felt and carbon foam with 60 ppi met both the criteria, with carbon foam with 60 ppi showing the least charge resistance for an electrolytic application.

### Example 2: Comparison of Porous Carbon Electrode to Planar Platinum Electrode

A porous carbon electrode was also compared to a planar Pt electrode. FIG. 2D compares the desalination performance over time of a “3D” carbon foam electrode to a conventional planar Pt electrode, showing that the 3D electrode achieved 86% desalination efficiency (DE) [(initial concentration-final concentration)/initial concentration] in 85 min, reached a target drinking water level, and had a 93% water recovery rate as compared to the planar electrode which achieved 33% demineralization efficiency without reaching the target drinking water level. The comparison was conducted using a flow rate of 400 ml/min and a voltage of 2.6 V.

### Example 3: Integration of Catalyst Material with Electrode Substrate

Various synthetic routes were developed to deposit catalysts (Pd, Cu, and Pd—Cu bimetallic systems) on carbon and other substrates. Pd and Cu were selected as most likely to have high selectivity for nitrate reduction. Electrodeposition allows the synthesis of catalysts directly on the most accessible electroactive sites of the support substrate, thereby increasing catalyst utilization efficiency.

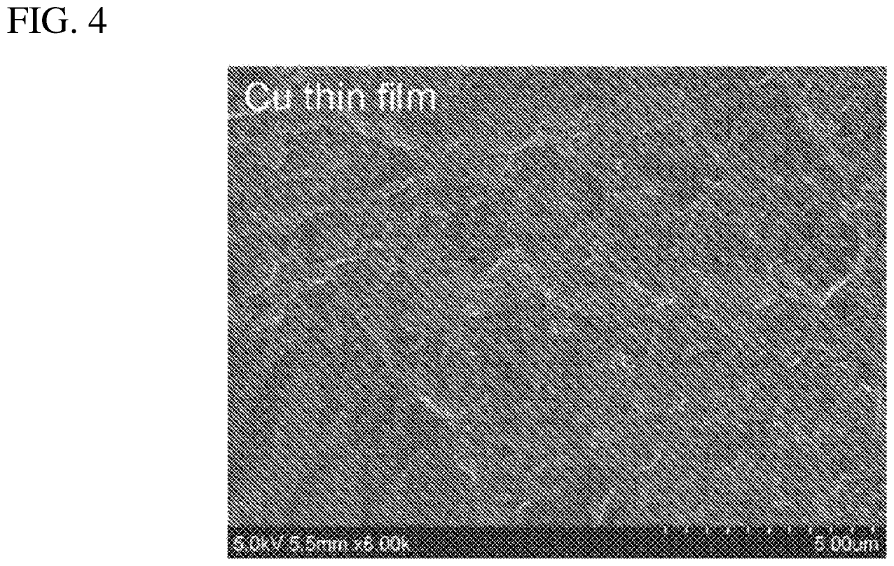

For bimetallic systems, two synthetic techniques were employed. The first technique utilized the co-electrodeposition of both metals in one single step. In the second technique, a base metal was first electrodeposited (Cu), which was then galvanically displaced by the second metal (Pd) having a lower oxidation potential than the displaced metal (Cu). While co-electrodeposition benefits from simplicity, electrodeposition followed by galvanic displacement enables good spatial for the deposition of the second metal. All synthesized catalysts were characterized for their morphology and elemental composition using SEM and energy dispersive spectroscopy (EDS). FIG. 4 illustrates an SEM images of a copper (Cu) thin film electrodeposited on a carbon substrate.

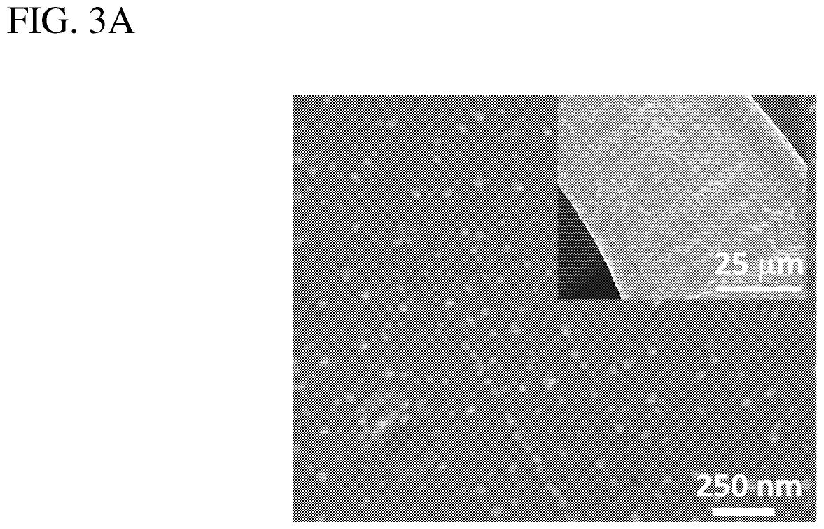

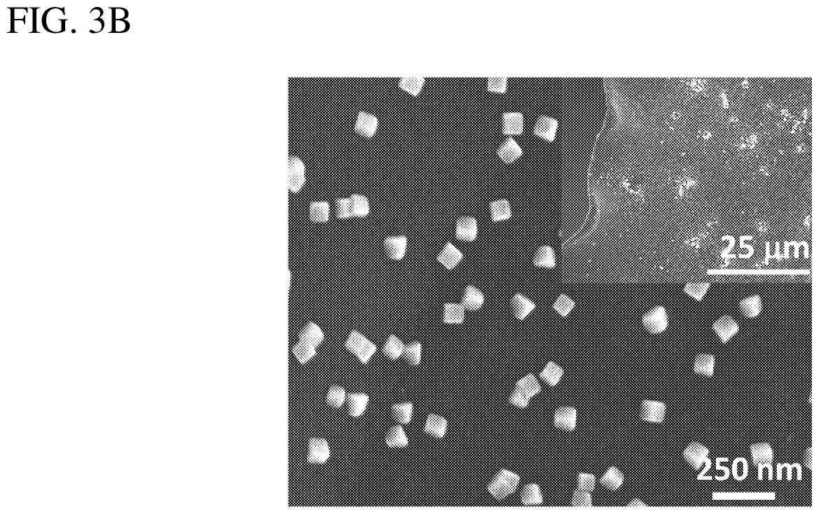

FIG. 3A shows scanning electron microscopy (SEM) images, including a high-magnification image and a lower-magnification inset image, of Cu nanoparticles deposited on a nickel foam substrate. As shown, a pulsed electrodeposition process produces Cu nanoparticles distributed on the nickel foam surface. In some embodiments, the Cu nanoparticles deposited on the nickel foam substrate may have an average particle diameter of about 35 nm.

FIG. 3B shows SEM images of Cu nanoparticles deposited under similar electrodeposition conditions on a carbon foam substrate. In comparison with the Cu nanoparticles deposited on the nickel foam substrate, the Cu nanoparticles deposited on the carbon foam substrate may have a larger average particle diameter, for example about 80 nm. This comparison demonstrates that the substrate material may influence the size, distribution, morphology, and/or nitrate reduction activity of the electrodeposited Cu nanoparticles.

### Example 4: Nitrate Reduction Using Different Catalyst Systems

Nitrate reduction studies were conducted in 30 mM NaNO₃ in 0.1 M NaOH electrolyte using a half-cell two-compartment electrochemical set-up. For control, electrochemical reduction studies were also carried out in 0.1 M NaOH electrolyte and 0.1 M NaOH with 30 mM NaNO₂ electrolyte.

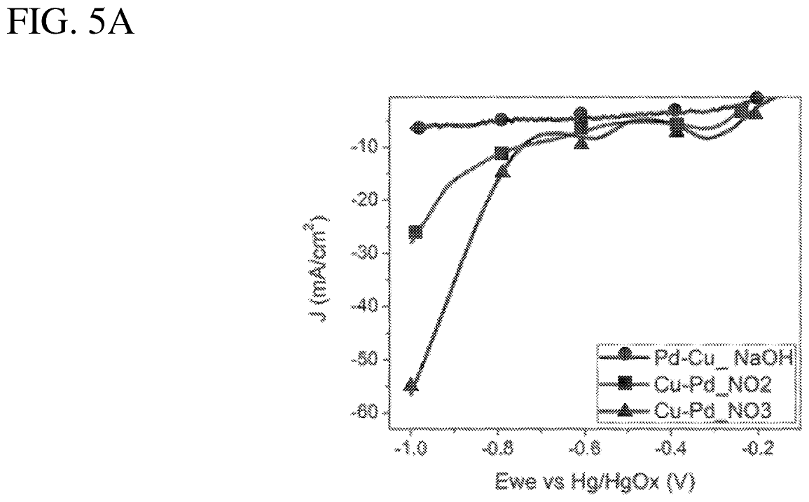

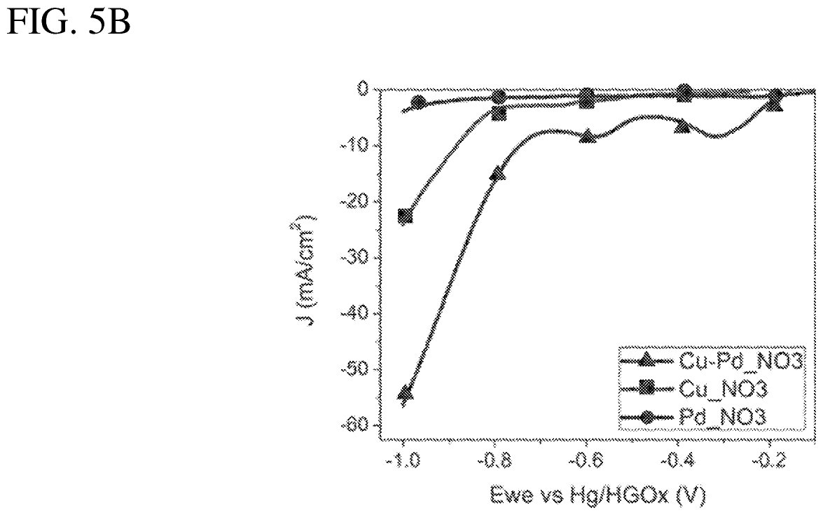

The catalytic activity of the Pd—Cu electrocatalyst for nitrate reduction was evaluated by linear sweep voltammetry measurements at 5 mV/s in N₂-saturated 0.1 M NaOH electrolyte with 30 mM NaNO₃ electrolyte, and the data are compared in the absence of nitrate ion concentration. Nitrogen was purged to minimize currents originating from the reduction of dissolved oxygen. As seen in FIG. 5A, a clear increase in reduction reaction currents was observed in the presence of nitrate ion concentration as the potential was scanned from −0.2V to −1.0 V vs. mercury/mercury oxide reference electrode. Potentials more negative than −1.0 V were not chosen to minimize hydrogen evolution due to water reduction reaction. The Pd—Cu system also showed an increase in reduction currents in the presence of nitrite ions. Interestingly, higher activity was obtained for nitrate reduction compared to nitrite reduction for potentials more negative than −0.8 V. FIG. 5B shows the effect of the catalytic system on nitrate reduction. Three different catalytic systems were compared: Pd; Cu; and Pd—Cu. As evidenced in FIG. 5B, the choice of catalyst affected the mix of nitrogen compounds formed by electroreduction, and the relative fractions of species were dependent on the voltage applied. This is exemplary that the inventive system operated accordingly with the electrode choice and in combination with the other operational and design factors as described herein, can enable a controllable choice of a nitrate-reduced mix of products.

### Example 5: Nitrate Reduction Conversion Efficiency

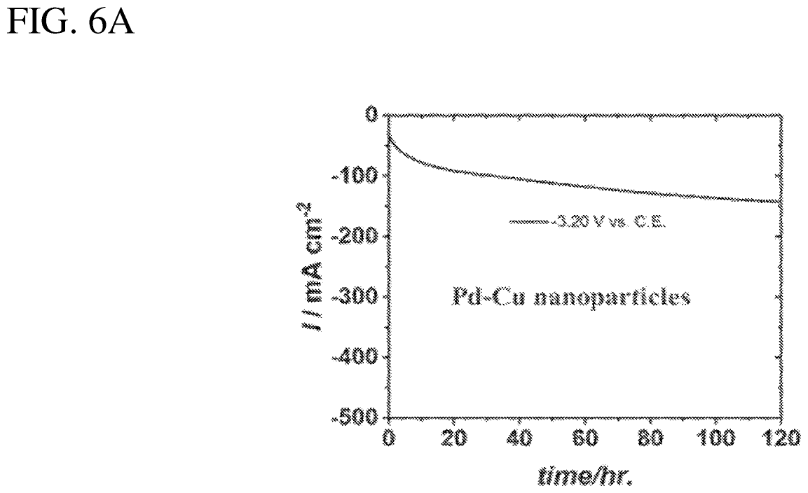

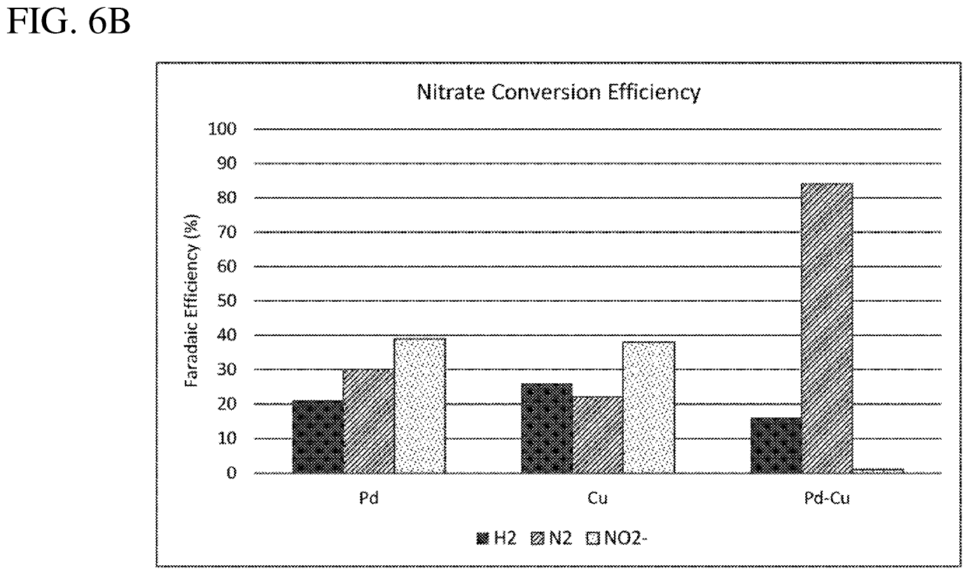

The Pd—Cu catalyst was then integrated into a half-cell configuration and tested for its stability for nitrate conversion under accelerated testing conditions (1 kA/m²=100 mA/cm²). Testing was conducted in 0.1 M NaNO₃ neutral electrolyte using an in-house half-cell two-compartment electrochemical set-up. FIG. 6A shows operation of the Pd—Cu nanoparticles at 3.2 V for over 100 hours. This voltage was chosen so the obtained currents are greater than 100 mA/cm². After 100 hours of operation, the products obtained from different catalyst materials synthesized were tested (FIG. 6B). Pd and Cu showed nitrite and nitrogen production in the range of Faradaic efficiencies of approximately 20% to 40% whereas Pd—Cu nanoparticles showed nitrate-to-nitrogen selectivity, reaching a nitrogen conversion efficiency of 84% after 100 hours of operation. Each of the catalysts operated at elevated overall efficiencies for nitrate reduction, showing less than about 25% hydrogen inefficiency in all cases.

### Example 6: Nitrate Removal from Different Feedwaters

We assessed the performance of the electrode assembly described in the previous Examples in different feed water sources listed in Table 3. For each feedwater chemistry, nitrate removal in electrodialysis mode, nitrate-to-nitrogen conversion in electrolysis mode, and freshwater recovery were experimentally determined. The initial nitrate concentration was 1000 mg/L and the temperature was maintained at 26° C.

TABLE 3

| | | | | Nitrate removal | Nitrate | Fresh |
|---|---|---|---|---|---|---|
| Feed | Sodium | Bicarbonate | Sulfate | from ED | Conversion | water recovery |
| 1 | 500 | 500 | 100 | 97 | 84 | 94 |
| 2 | 2000 | 2000 | 500 | 98 | 82 | 97 |
| 3 | 5000 | 5000 | 1000 | 97 | 79 | 93 |
| | | | | Nitrate removal | Nitrate | Fresh |
| | Caclium | Sulfate | Na + Mg | from ED | Conversion | water recovery |
| 4 | 500 | 500 | 100 | 95 | 82 | 92 |
| 5 | 2000 | 2000 | 500 | 98 | 88 | 91 |
| 6 | 5000 | 5000 | 1000 | 95 | 79 | 90 |
| | | | | Nitrate removal | Nitrate | Fresh |
| | Sodium | Chloride | | from ED | Conversion | water recovery |
| 7 | 500 | 500 | | 97 | 86 | 96 |
| 8 | 2000 | 2000 | | 98 | 83 | 97 |
| 9 | 5000 | 5000 | | 89 | 74 | 95 |

| | | | Nitrate removal | Nitrate | Fresh |
|---|---|---|---|---|---|
| | Silica | Sodium + Chloride | from ED | Conversion | water recovery |
| 7 | 0.5 | 1000 | 94 | 80 | 95 |
| 8 | 1 | 2000 | 98 | 78 | 93 |
| 9 | 2.5 | 5000 | 89 | 71 | 95 |

Table 3 shows that for all different feed water chemistries tested, we were able to achieve freshwater recovery of 85% and higher. We were also able to achieve nitrate-to-nitrogen conversion efficiencies >75% for all feed water chemistries, the only exception being feedwaters with chloride ion concentration equal to 5000 mg/L.

### Example 7: Porous Electrode in Capacitive Deionization Configuration

An electrodialysis unit having an effective electrode area of 64 cm² was modified by incorporating nickel foam electrodes (64 cm², 60 ppi) on both the anode side and the cathode side, with a single membrane pair, to represent a capacitive deionization system. The unit (1000), as illustrated in FIG. 10, was configured as a three-compartment cell comprising an anolyte chamber (1004) containing an anodic electrode (1002), a central feedwater chamber (1006) through which feedwater flowed, and a catholyte chamber (1012) containing a cathodic electrode (1014). An anion exchange membrane (1008) separated the anolyte chamber (1004) from the feedwater chamber (1006), and a cation exchange membrane (1010) separated the feedwater chamber (1006) from the catholyte chamber (1012).

At room temperature, solution circulation was maintained by two peristaltic pumps operating at 300 mL/min, with one pump circulating the anolyte (1016) and catholyte (1020) solutions and the other pump circulating the feedwater chamber solution (1018). Each chamber was initially charged with an electrolyte containing 30 mM sodium nitrate and 0.1 M sodium hydroxide, adjusted to pH 7. A conductivity meter was positioned in the feedwater chamber reservoir to monitor the conductivity throughout operation, with measurements recorded at 10-minute intervals. A potentiostat was used to apply an on/off voltage protocol of 1.2 V, a standard cell voltage used for capacitive deionization, for 20 seconds and 0 V versus open circuit voltage for 10 seconds over a total experimental period of 80 minutes.

FIG. 11 shows the conductivity of the feedwater chamber (1006) as a function of time during operation in capacitive deionization mode. Throughout the 80-minute experiment conducted at an applied voltage of 1.2 V, the conductivity remained substantially constant, from about 6.6 mS/cm to about 6.5 mS/cm. The absence of a significant decrease in conductivity indicates that, under these conditions and with the electrode configuration used, little or no nitrate removal was achieved.

For comparison, FIG. 2D illustrates desalination performance in electrodialysis mode using a 3D carbon foam electrode and a planar Pt electrode. The 3D electrode achieved 86% desalination efficiency and the planar electrode achieved 33% demineralization efficiency. These results demonstrate that an electrodialysis configuration operated under capacitive deionization conditions is not well suited for efficient ion removal from feedwater and subsequent ion concentration for further treatment in an electrolysis mode.

### Example 8: Electrolytic Conversion of Nitrate and Nitrite to Ammonium and Nitrogen

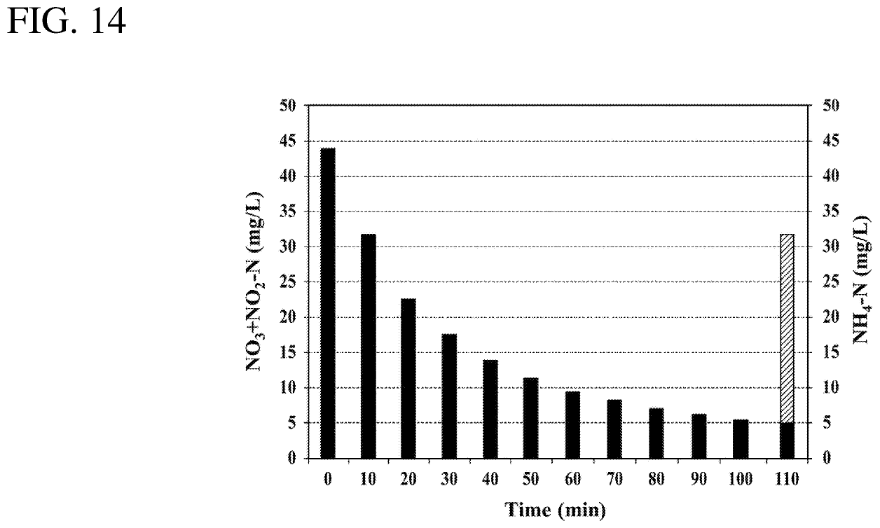

In some embodiments, a catalyst selected based on nitrate reduction activity may be integrated into an electrolyzer configured for continuous nitrate reduction. The electrolyzer may be operated to convert nitrate-containing water to reduced nitrogen species, including ammonium and nitrogen gas. In one exemplary embodiment, a 64 cm² electrodialysis unit was reconfigured as an electrolyzer and used to evaluate catalyst performance under continuous-flow nitrate reduction conditions. As illustrated in FIG. 14, combined nitrate/nitrite concentrations decreased over time during electrolysis, while ammonium and nitrogen products were generated. After about 110 minutes of operation, greater than about 90% of the nitrate was electrolytically converted to ammonium and nitrogen, with greater than about 70% selectivity toward ammonium. The results demonstrate that the catalyst-coated electrode can be used in a continuous electrolyzer configuration to achieve high nitrate conversion efficiency and selective ammonium production. In some embodiments, the use of a reconfigured 64 cm² electrolyzer may provide information regarding flow behavior, ohmic losses, nitrate conversion efficiency, product selectivity, and catalyst performance. Such information may be used to design and optimize larger-scale electrolyzers for nitrate conversion to ammonia and/or nitrogen.

### Example 9: Integrated Electrodialysis and Electrolysis Nitrate Removal and Conversion Using Catalyst-Coated Foam Electrodes

A laboratory-scale integrated electrodialysis and electrolysis system was assembled using catalyst-coated three-dimensional foam electrodes. A nitrate reduction catalyst selected based on nitrate reduction activity was deposited onto a conductive porous foam substrate, such as nickel foam or titanium foam. The catalyst-coated foam electrode was then integrated into a hybrid electrodialysis and electrolysis unit configured to operate in an electrodialysis mode for nitrate removal and in an electrolysis mode for nitrate conversion.

A simulated nitrate-containing aqueous solution was prepared using sodium nitrate as the nitrate source. The solution was introduced into the hybrid electrodialysis/electrolysis unit and subjected to nitrate removal in electrodialysis mode.

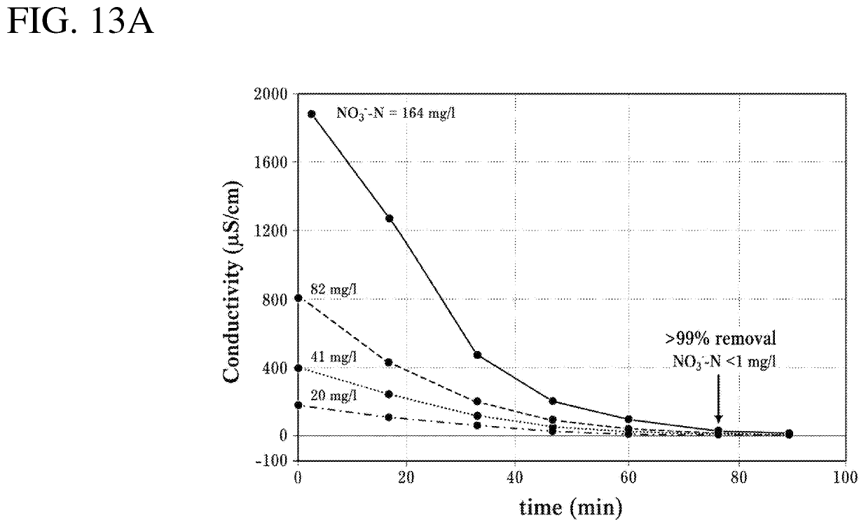

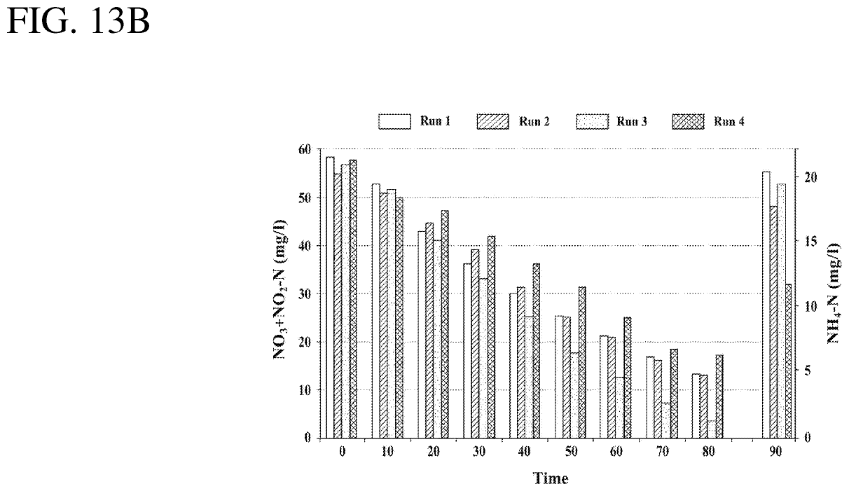

For nitrate removal experiments, a 64 cm² electrodialysis unit was operated at a constant current density of about 500 mA/cm². Nitrate removal was evaluated as a function of initial nitrate concentration. Under the tested conditions, greater than about 99% nitrate removal was achieved after approximately one hour of operation, as illustrated in FIG. 13A, demonstrating effective nitrate separation from the simulated nitrate-containing stream.

For nitrate conversion experiments, the system was operated in electrolysis mode using catalyst-coated three-dimensional foam electrodes. The nitrate conversion experiments were performed at initial nitrate concentrations of less than about 60 mg/L as nitrogen. A voltage of about 2 V was applied during electrolysis to convert nitrate to reduced nitrogen species, including ammonium. Repeated nitrate conversion experiments showed greater than about 80% overall nitrogen-based anion conversion, as illustrated in FIG. 13B, with about 40% selectivity toward ammonium.

The repeated electrolysis results indicate that the catalyst-coated foam electrodes maintained activity over multiple cycles. In some embodiments, nitrate conversion efficiency may increase over repeated operation, suggesting that the catalyst-coated electrode and integrated electrodialysis and electrolysis configuration can provide stable performance for nitrate removal and subsequent electrochemical conversion to ammonium or other nitrogen-containing products.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

1. A system for removing and electro-reducing nitrogen-based anions from feedwater comprising nitrogen-based solutes, the system comprising:
an integrated electrodialysis and electrolysis device comprising a first electrode;
a second electrode positioned opposite the first electrode;
a first ion exchange membrane adjacent to the first electrode, and a second ion exchange membrane adjacent to the second electrode and positioned between the first and the second electrodes to define a central compartment between the first and second ion exchange membranes, a first electrode compartment defined between said first ion exchange membrane and the first electrode, and a second electrode compartment defined between said second ion exchange membrane and the second electrode;
feedwater inlets and effluent outlets in fluid communication with said central compartment and said first electrode compartment and said second electrode compartment; and
a source of DC electrical power connected to said first electrode and said second electrode.

2. The system of claim 1, wherein said first electrode is adjacent to or in direct contact with said first electrode compartment and comprises an electrically conductive 3-dimensional macroporous open-cell scaffold comprising a coating of a selective electro-reductive catalyst for nitrogen-based ion reduction, the scaffold having an electrochemically active surface area of greater than 10 times its compartment-exposed geometric area.

3. The system of claim 2, wherein said scaffold surface is comprised of nickel or titanium.

4. The system of claim 1, further comprising fluid control valves in fluid communication with each of the feedwater inlets and effluent outlets and arranged to control inlet and effluent water flows and combinations thereof to and from each of the respective compartments.

5. The system of claim 1, wherein said system is comprised of at least two systems operated in series.

6. The system of claim 1, further comprising a plurality of ordered and repeating cation exchange membranes and anion exchange membranes positioned between said first and second ion exchange membranes, and defining a plurality of central compartments to form alternating diluting and concentrating compartments.

7. The system of claim 6, wherein at least one of the effluent outlets of the central concentrating compartments or the effluent outlet of the second electrode compartment is in fluid communication with the feedwater inlet of the first electrode compartment.

8. A method for removing and electro-reducing nitrate anion from feedwater comprising nitrate or nitrite solutes, the method comprising:
providing an integrated electrodialysis and electrolysis hybrid system comprising a first electrode comprised of an electrically conductive chemically inert scaffold material having a coating of selective electro-reductive catalyst for nitrogen-based anion reduction, a second electrode positioned opposite the first electrode, and a first ion exchange membrane adjacent to the first electrode, and a second ion exchange membrane adjacent to the second electrode and positioned between the first and the second electrodes to define a central compartment between the anion exchange membrane and the cation exchange membrane, a first electrode compartment defined between said first ion exchange membrane and the first electrode, and a second electrode compartment defined between said second ion exchange membrane and the second electrode;
passing the feedwater water into the central compartment and the first and the second electrode compartments;
operating the hybrid system for a first time period in an electrodialysis mode by imposing an anodic polarity across the first electrode and a cathodic polarity across the second electrode to produce a concentration of nitrate or nitrite ion in the central compartment that is lower than the concentration of nitrate or nitrite ion in the feedwater, and producing a water in the first electrode compartment that includes nitrate or nitrite anions; and
operating the hybrid system, for a second time period, in an electrolysis mode by reversing the polarity across the first and the second electrodes, such that the first electrode becomes cathodic with respect to the second electrode, and whereby nitrogen-based anions in the first electrode compartment are electro-reduced to form one or a combination of reaction products comprising nitrite, ammonia, ammonium, or nitrogen gas.

9. The method of claim 8, wherein the system comprises two or more central compartments and the system is operated such that the first electrode compartment is fluidly connected with at least one the effluent outlets of the central compartments that are in concentration mode or the outlet of the second electrode compartment during the time period when the hybrid system is operated in the electrolysis mode and wherein electrodialysis and electroreduction occurs simultaneously and wherein the electrical polarity of the first and second electrodes is not reversed.

10. The method of claim 8, wherein said system is comprised of at least two systems operated in series and wherein the feedwater inlet to the first electrode compartment is fluidly connected to the effluent outlet of the second electrode compartment when the hybrid system is operated in either or both the electrolysis mode or electrodialysis mode.

11. A system for removing and electro-reducing nitrogen-based anions from feedwater comprising nitrogen-based solutes, the system comprising:
an integrated electrodialysis and electrolysis device comprising a first electrode;
a second electrode positioned opposite the first electrode;
a first ion exchange membrane adjacent to the first electrode, and a second ion exchange membrane adjacent to the second electrode and positioned between the first and the second electrodes, a plurality of ordered and repeating cation exchange membranes and anion exchange membranes positioned between said ion exchange membranes, and defining a plurality of central compartments forming alternating diluting and concentrating compartments between the ion exchange membranes, a first electrode compartment defined between said first ion exchange membrane and the first electrode, and a second electrode compartment defined between said second ion exchange membrane and the second electrode;
feedwater inlets and effluent outlets in fluid communication with said central compartments and said first electrode compartment and said second electrode compartment; and
a source of DC electrical power connected to said first electrode and said second electrode.

12. The system of claim 11, further comprising fluid control valves in fluid communication with each of the feedwater and electrode compartment inlets and effluent outlets and arranged to control changes in the feedwater and effluent water flows and combinations thereof to and from each of the respective compartments.

13. The system of claim 11, wherein at least one of the first electrode and second electrode comprise an electrically conductive 3-dimensional macroporous open-cell scaffold comprising a chemically inert scaffold material comprising a coating of a selective electro-reductive catalyst for nitrate reduction, the scaffold having an electrochemically active surface area of greater than 10 times its compartment-exposed geometric area.

14. The system of claim 13, wherein said scaffold surfaces are coated with a copper catalyst.

15. The system of claim 14, wherein said scaffold surfaces are comprised of nickel or titanium.

16. The system of claim 11, wherein at least one of the effluent outlets of the concentrating compartments and the effluent outlet of the second electrode compartment are in fluid communication with the feedwater inlet of the first electrode compartment and/or at least one of the effluent outlets of the concentrating compartments and the effluent outlet of the first electrode compartment are in fluid communication with the feedwater inlet of the second electrode compartment.

17. The system of claim 16, further comprising at least one of a first holding tank in fluid communication with the first electrode compartment and configured to receive and recirculate a concentrate stream to the first electrode compartment, a second holding tank in fluid communication with the second electrode compartment and configured to receive the effluent of the second electrode compartment prior to introduction of the effluent into the first electrode compartment, and a third holding tank configured to receive and store the effluent stream from the one or more central compartments prior to feeding the effluent stream to the second electrode compartment.

18. The system of claim 17, further comprising a degasifier positioned at least one of between the second holding tank and the first electrode compartment and upstream of the second electrode compartment, wherein the degasifier is configured to remove oxygen gas from at least one of the effluent of the second electrode compartment prior to introduction of the effluent into the first electrode compartment and the stream from the first electrode compartment and/or effluent stream prior to introduction into the second electrode compartment.

19. The system of claim 11, wherein the ion exchange membrane adjacent to the first electrode and the ion exchange membrane adjacent to the second electrode are independently selected from a cation exchange membrane or an anion exchange membrane.

20. A method of operating the system of claim 11, the method comprising:
operating the first electrode and the second electrode under a first polarity condition in which the first electrode functions as a cathode and electroreduces nitrogen-based anions to produce a selected distribution of reduced nitrogen based products, wherein the selected distribution of reduced nitrogen-based products is controlled by varying one or more of catalyst composition, pH of a solution in contact with the first electrode compartment during electroreduction, operating voltage gradient at a catalyst surface, and residence time of a nitrogen species within the first electrode compartment; and
controlling one or more valves to direct feedwater through alternating opposing cells defined by the plurality of ordered and repeating cation exchange membranes and anion exchange membranes such that water purification and nitrate concentration occur continuously regardless of whether polarity of the electrodes is reversed or not reversed.
